(19) United States
(12) Patent Application Publication
(10) Pub. No.: US 2025/0333079 A1
(43) Pub. Date: Oct. 30, 2025

(54) TECHNIQUES FOR CONTROLLING AUTONOMOUS VEHICLES USING VISION-LANGUAGE MODELS

(71) Applicant: NVIDIA CORPORATION, Santa Clara, CA (US)

(72) Inventors: Apoorva SHARMA, Oakland, CA (US); Sushant VEER, Sunnyvale, CA (US); Yan WANG, Santa Clara, CA (US); Marco PAVONE, Stanford, CA (US)

(21) Appl. No.: 18/935,346

(22) Filed: Nov. 1, 2024

Related U.S. Application Data
(60) Provisional application No. 63/638,738, filed on Apr. 25, 2024.

(51) Int. Cl. B60W 60/00; G06F 40/40; G06V 10/774; G06V 20/58

(52) U.S. Cl. CPC B60W 60/0015; G06V 10/774; G06V 20/58; B60W 2556/40; G06F 40/40

(57) ABSTRACT

One embodiment of a method for controlling vehicles includes generating, based on sensor data, a first plan for controlling a vehicle, generating, using a trained visual language model (VLM), a final plan for controlling the vehicle based on the first plan and a second plan, and controlling the vehicle based on the final plan.

### CROSS-REFERENCE TO RELATED APPLICATIONS

This application claims priority benefit of the United States Provisional Patent Application titled, “FOUNDATIONAL MODEL APPROACH FOR TASK-RELEVANT PERCEPTION FAILURE DETECTION IN AUTONOMOUS VEHICLES,” filed on Apr. 25, 2024 and having Ser. No. 63/638,738. The subject matter of this related application is hereby incorporated herein by reference.

### BACKGROUND

### Technical Field

Embodiments of the present disclosure relate generally to computer science, artificial intelligence (AI), and autonomous vehicles and, more specifically, to techniques for controlling autonomous vehicles using vision-language models.

### Description of the Related Art

Autonomous vehicles (AVs) are vehicles that can operate without human intervention. An AV system controls and navigates a vehicle using input from a combination of sensors and cameras that perceive the surrounding environment. AV systems rely on machine learning (ML) models to interpret data from the surrounding environment to make decisions such as steering, accelerating, braking, and responding to road conditions, traffic signs, and obstacles. Although the ML models are trained to control vehicles using vast amounts of driving data, the ML models can fail to make correct decisions in difficult scenarios that were not previously shown to the ML models during training. For example, a failure can occur when an ML model does not understand the surrounding environment correctly. Safe deployment of AV systems requires safe decisions to be made even when such failures occur.

One approach for safe deployment of AV systems is to use runtime monitoring to alert the AV system when decisions made by an ML model are untrustworthy. For example, to identify a future collision caused by the decision of an ML model, the runtime monitoring system could detect obstacles and traffic elements, hypothesize future behavior of the detected obstacles, understand the behavior plan of the vehicle given the future behavior of the obstacles, and ensures the plan satisfies safety constraints that will prevent a collision. Some conventional runtime monitoring systems use heuristic that provide a set of rules to check the trustworthiness of decisions made by the ML models of AV systems. For example, the heuristics can include checking the consistency of information provided by different sensors or monitoring the temporal consistency of the information provided by each sensor, which can affect the decisions made by the ML models.

One drawback of the above approach for runtime monitoring is that the heuristics can fail to take into account context of the environment that the AV is operating in, such as understanding the behavior of obstacles in the path of the AV. Another drawback is the heuristics oftentimes fail to properly consider the impact of mistakes the AV system makes in understanding a scene, such as incorrectly identifying a pedestrian as a traffic sign. In addition, the heuristics are oftentimes not holistic and may not consider some of the elements in the scene that need to be considered for the AV to drive safely. As a result, using heuristics in the runtime monitoring of AV systems can result in erroneous control of vehicles that can be dangerous and raise safety concerns.

As the foregoing illustrates, what is needed in the art are more effective techniques for controlling autonomous vehicles.

### SUMMARY

One embodiment of the present disclosure sets forth a computer-implemented method for controlling vehicles. The method includes generating, based on sensor data, a first plan for controlling a vehicle. The method further includes generating, using a trained visual language model (VLM), a final plan for controlling the vehicle based on the first plan and a second plan. In addition, the method includes controlling the vehicle based on the final plan.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, with the disclosed techniques, runtime monitoring of an AV system uses a VLM to understand broader contexts in an environment, such as understanding the likely behaviors of unusual but relevant obstacles or traffic elements. In addition, with the disclosed techniques, an AV can be correctly controlled to adapt to specific environmental conditions, such as slowing down to avoid obstacles or remaining on the road, resulting in the AV being driven in a relatively safe manner. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 illustrates is a more detailed illustration of the fine-tuning server of FIG. 1, according to various embodiments;

FIG. 3 is a more detailed illustration of the computing device of FIG. 1, according to various embodiments;

FIG. 4A is an illustration of an exemplar autonomous vehicle, according to various embodiments;

FIG. 4B illustrates exemplar camera locations and fields of view for the exemplar autonomous vehicle of FIG. 4A, according to various embodiments

FIG. 4C is a block diagram of an exemplar system architecture for the exemplar autonomous vehicle of FIG. 4A, according to various embodiments;

FIG. 4D is a system diagram for communication between cloud-based server(s) and the exemplar autonomous vehicle of FIG. 4A, according to various embodiments

FIG. 5 is a more detailed illustration of the re-training application of FIG. 1, according to various embodiments;

FIG. 6 is a more detailed illustration of the application of FIG. 1, according to various embodiments;

FIG. 7 is a flow diagram of method steps for re-training a vision-language model, according to various embodiments; and

FIG. 8 is a flow diagram of method steps for generating a safe plan to control an autonomous vehicle, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for controlling vehicles using a vision-language model (VLM) powered runtime monitoring system. In some embodiments, the runtime monitoring system inputs, into a VLM, sensor data, detections such as detected obstacles within an environment, and a generated plan of future behavior for a vehicle. In such cases, the runtime monitoring system can generate a prompt for the VLM that includes embeddings or natural language words representing the sensor data, the detections, and the plan. The prompt asks the VLM to evaluate the plan for safety risks. In some embodiments, the prompt can also include outputs of auxiliary tools, such as physics-based or geometry-based models that compute trajectories of objects, check for collisions, perform simulations, and/or the like. Given the prompt, the VLM generates a risk score or program code that can be executed to compute the risk score and that can utilize the auxiliary tools. A fallback decision logic decides to execute the plan or to perform an alternate maneuver, such as a predefined maneuver to minimize risk. In some embodiments, the VLM can be trained be fine-tuning a pre-trained VLM using training data that includes risk scores for sensor data that are automatically generated using the auxiliary tools or annotated manually.

The techniques for controlling vehicles using a VLM powered runtime monitoring system have many real-world applications. For example, those techniques could be used to control autonomous or semiautonomous vehicles within real-world or virtual environments.

The above examples are not in any way intended to be limiting. As persons skilled in the art will appreciate, as a general matter, the techniques for controlling vehicles described herein can be implemented in any suitable application.

### System Overview

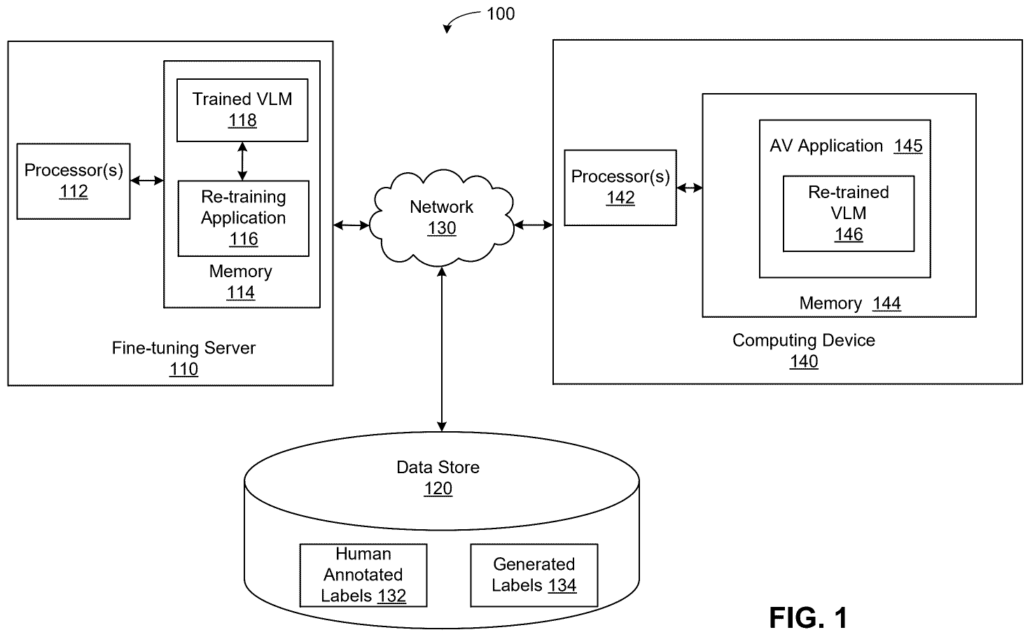

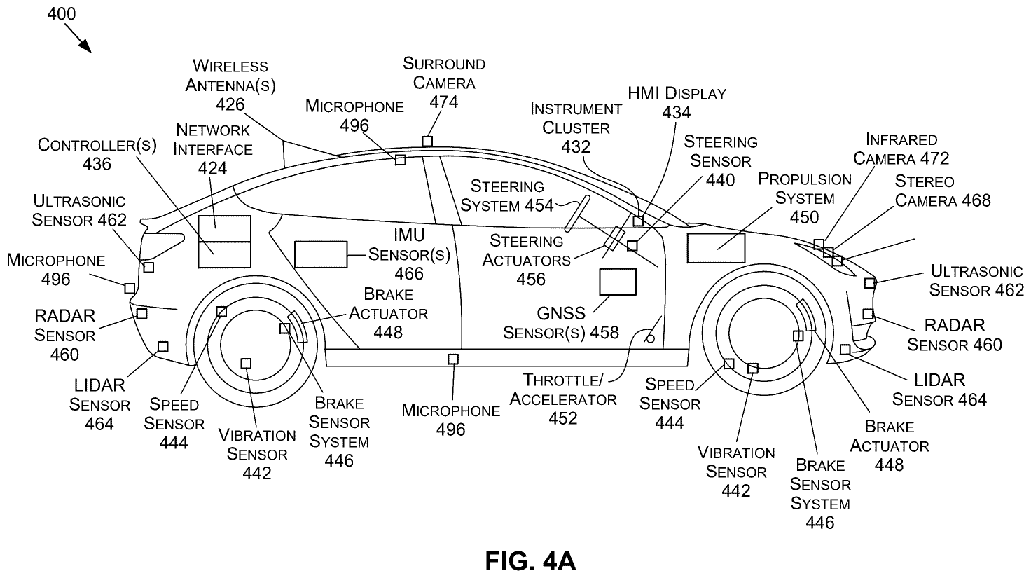

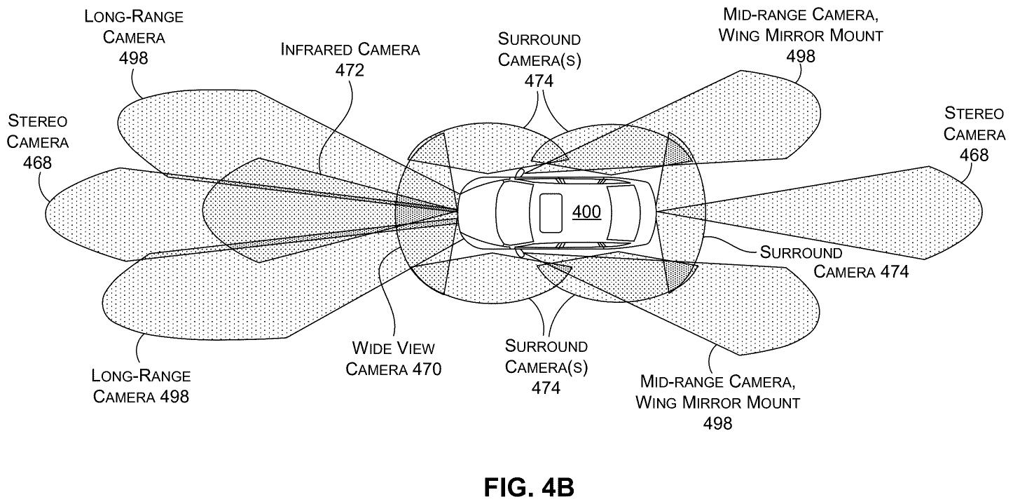

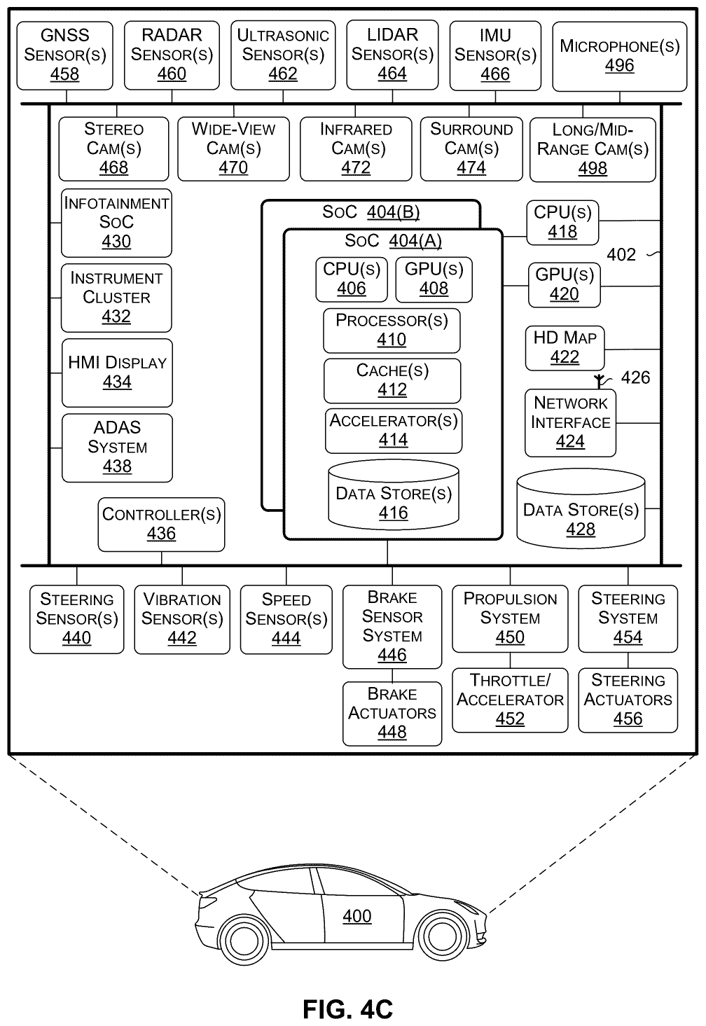

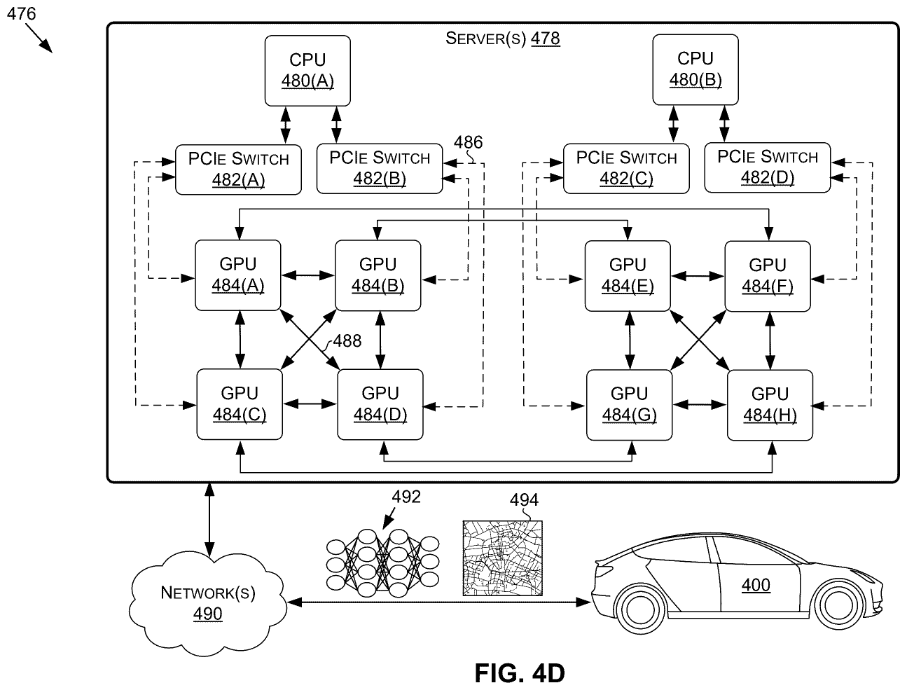

FIG. 1 illustrates a block diagram of a computer-based system 100 configured to implement one or more aspects of the various embodiments. As shown, system 100 includes, without limitation, a fine-tuning server 110, a data store 120, a network 130, and a computing device 140. Fine-tuning server 110 includes, without limitation, processor(s) 112 and a system memory 114. Memory 114 includes, without limitation, a re-training application 116 and a trained vision-language model (VLM) 118. Computing device 140 includes, without limitation, processor(s) 142 and memory 144. Memory 144 includes, without limitation, an AV application 145 which includes a re-trained VLM 146. Data store 120 includes, without limitation, auxiliary tools 122, human-annotated labels 132, and generated labels 134. In some embodiments, computing device 140 can be included in an autonomous vehicle, as described in greater detail below in conjunction with FIGS. 4A-4D.

Fine-tuning server 110 shown herein is for illustrative purposes only, and variations and modifications are possible without departing from the scope of the present disclosure. For example, the number and types of processors 112, the number and types of system memories 114, and/or the number of applications included in the system memory 114 can be modified as desired. Further, the connection topology between the various units in FIG. 1 can be modified as desired. In some embodiments, any combination of the processor(s) 112 and the system memory 114 can be included in and/or replaced with any type of virtual computing system, distributed computing system, and/or cloud computing environment, such as a public, private, or a hybrid cloud system.

Processor(s) 112 receive user input from input devices, such as a keyboard or a mouse. Processor(s) 112 can be any technically feasible form of processing device configured to process data and execute program code. For example, any of processor(s) 112 could be a central processing unit (CPU), a graphics processing unit (GPU), an application-specific integrated circuit (ASIC), a field-programmable gate array (FPGA), and so forth. In various embodiments any of the operations and/or functions described herein can be performed by processor(s) 112, or any combination of these different processors, such as a CPU working in cooperation with a one or more GPUs. In various embodiments, the one or more GPU(s) perform parallel processing tasks, such as VLM 118 computations. Processor(s) 112 can also receive user input from input devices, such as a keyboard or a mouse and generate output on one or more displays.

System memory 114 of fine-tuning server 110 stores content, such as software applications and data, for use by processor(s) 112. System memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace system memory 114. The storage can include any number and type of external memories that are accessible to processor(s) 112. For example, and without limitation, the storage can include a Secure Digital Card, an external Flash memory, a portable compact disc read-only memory (CD-ROM), an optical storage device, a magnetic storage device, and/or any suitable combination of the foregoing.

Re-training application 116 is configured to re-train a trained vision-language model (VLM), such as trained VLM 118, using training data. The training data, shown as human-annotated labels 132 and generated labels 134, can be stored in data store 120. In some embodiments, re-training application 116 can receive vehicle sensor data and generate labels 134 using auxiliary tools 122. Although described herein primarily with respect to re-training a trained VLM to fine-tune the VLM, in some embodiments, a VLM can be trained from scratch.

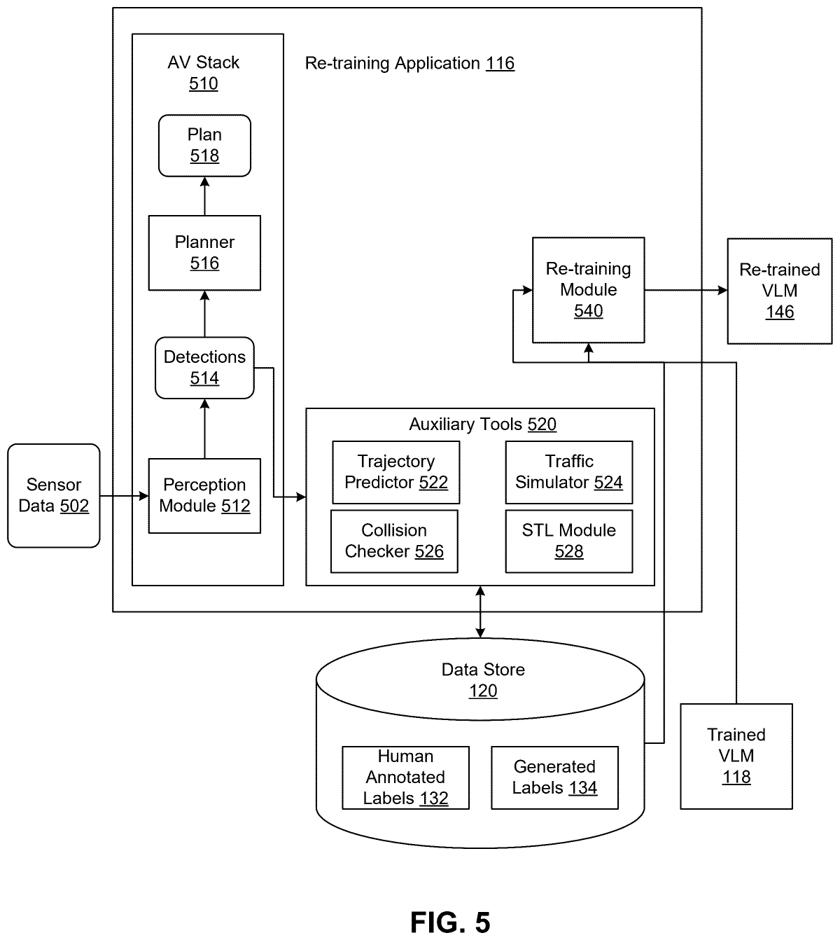

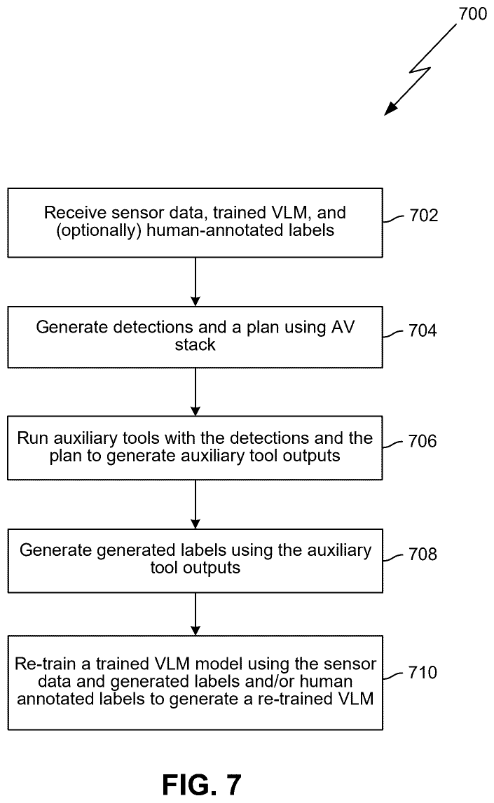

Trained VLM 118 can be any type of technically feasible machine learning model. For example, in various embodiments, trained VLM 118 can be a transformer-based VLM, such as a LLaMA (Large Language Model Meta AI), with a generative model architecture. The operations performed by re-training application 116 to re-train the trained LLM model are described in greater detail below in conjunction with FIGS. 5 and 7.

Data store 120 provides non-volatile storage for applications and data in fine-tuning server 110 and computing device 140. For example, and without limitation, training data, trained (or deployed) machine learning models and/or application data, including trained VLM 118, human-annotated labels 132, and generated labels 134, can be stored in the data store 120. In some embodiments, data store 120 can include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Data store 120 can be a network attached storage (NAS) and/or a storage area-network (SAN). Although shown as coupled to fine-tuning server 110 and computing device 140 via network 130, in various embodiments, fine-tuning server 110 or computing device 140 can include data store 120.

Network 130 includes any technically feasible type of communications network that allows data to be exchanged between fine-tuning server 110, computing device 140, data store 120 and external entities or devices, such as a web server or another networked computing device. For example, network 130 can include a wide area network (WAN), a local area network (LAN), a cellular network, a wireless (WiFi) network, and/or the Internet, among others.

Computing device 140 shown herein is for illustrative purposes only, and variations and modifications are possible without departing from the scope of the present disclosure. For example, the number and types of processors 142, the number and types of system memories 144, and/or the number of applications included in the system memory 144 can be modified as desired. Further, the connection topology between the various units in FIG. 1 can be modified as desired. In some embodiments, any combination of the processor(s) 142 and/or the system memory 144 can be included in and/or replaced with any type of virtual computing system, distributed computing system, and/or cloud computing environment, such as a public, private, or a hybrid cloud system.

Processor(s) 142 of computer device 140 receive user input from input devices, such as a keyboard or a mouse. Processor(s) 142 can be any technically feasible form of processing device configured to process data and execute program code. For example, any of processor(s) 142 could be a central processing unit (CPU), a graphics processing unit (GPU), an application-specific integrated circuit (ASIC), a field-programmable gate array (FPGA), and so forth. In various embodiments any of the operations and/or functions described herein can be performed by processor(s) 142, or any combination of these different processors, such as a CPU working in cooperation with a one or more GPUs. In various embodiments, the one or more GPU(s) perform parallel processing task, such as VLM computations. Processor(s) 142 can also receive user input from input devices, such as a keyboard or a mouse and generate output on one or more displays.

Similar to memory 114 of fine-tuning server 110, memory 144 of computing device 140 stores content, such as software applications and data, for use by the processor(s) 142. System memory 144 can be any type of memory capable of storing data and software applications, such as a RAM, ROM, EPROM, Flash ROM, or any suitable combination of the foregoing. In some embodiments, a storage (not shown) can supplement or replace the system memory 144. The storage can include any number and type of external memories that are accessible to processor 142. For example, and without limitation, the storage can include a Secure Digital Card, an external Flash memory, a portable CD-ROM, an optical storage device, a magnetic storage device, and/or any suitable combination of the foregoing.

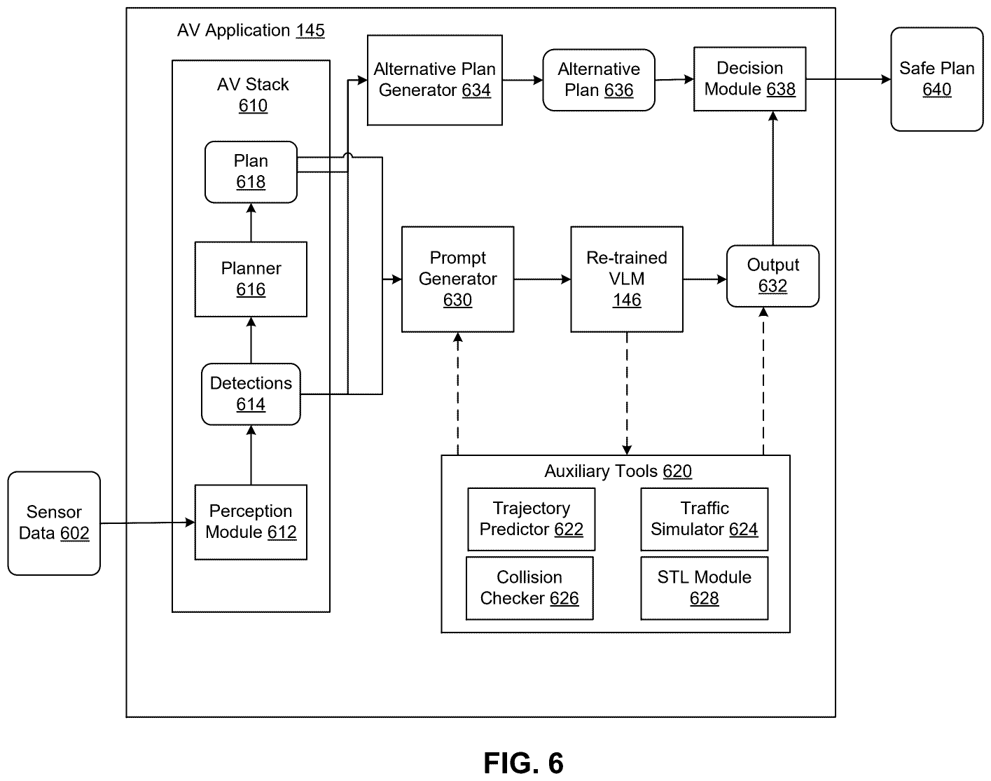

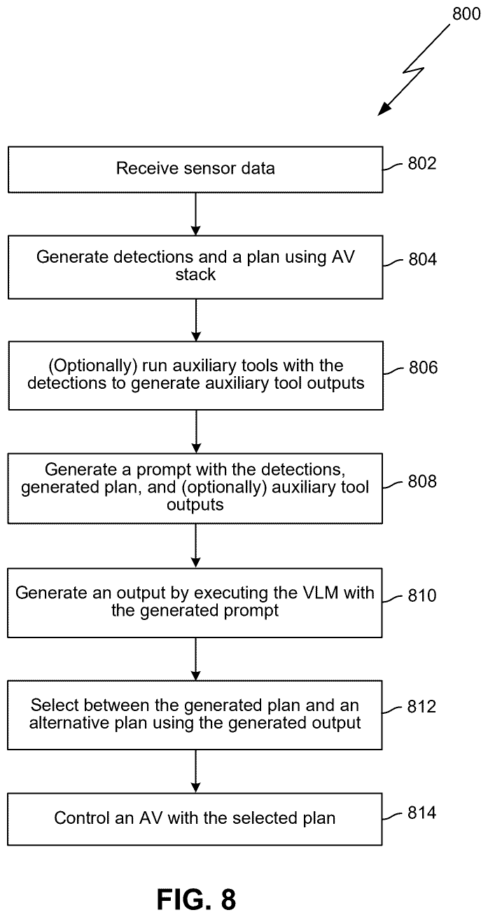

To control a vehicle, AV application 145 receives sensor data. Given the sensor data, AV application 145 generates a plan for the vehicle to follow and uses re-trained VLM 146 to choose between the plan or an alternative plan that reduces risk, as discussed in greater detail below in conjunction with FIGS. 6 and 8. AV application 145 controls the vehicle to steer, accelerate, and brake according to the selected plan. Re-trained VLM 146 can be any type of technically feasible machine learning model that is able to process text and images simultaneously to perform visual-language tasks, such as visual question answering, image captioning, and/or text-to-image search. For example, in various embodiments, re-trained VLM 146 can be a transformer-based VLM, such as a VILBERT, with any suitable architecture.

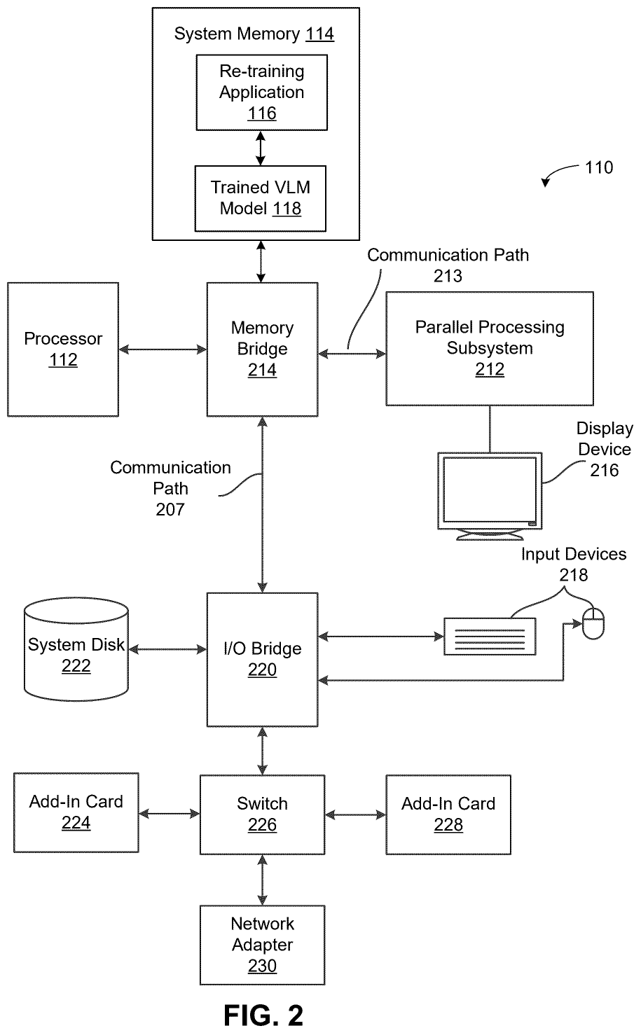

FIG. 2 illustrates is a more detailed illustration of fine-tuning server 110 of FIG. 1, according to various embodiments. As persons skilled in the art will appreciate, fine-tuning server 110 can be any type of technically feasible computer system, including, without limitation, a server machine, a server platform, a desktop machine, laptop machine, a hand-held/mobile device, or a wearable device. In some embodiments, fine-tuning server 110 is a server machine operating in a data center or a cloud computing environment that provides scalable computing resources as a service over a network.

In various embodiments, fine-tuning server 110 includes, without limitation, a processor 112 and a memory 114 coupled to a parallel processing subsystem 212 via a memory bridge 214 and a communication path 213. Memory bridge 214 is further coupled to an I/O (input/output) bridge 220 via a communication path 207, and I/O bridge 220 is, in turn, coupled to a switch 226.

In some embodiments, I/O bridge 220 is configured to receive user input information from optional input devices 218, such as a keyboard or a mouse, and forward the input information to processor 112 for processing via communication path 213 and memory bridge 214. In some embodiments, fine-tuning server 110 may be a server machine in a cloud computing environment. In such embodiments, fine-tuning server 110 may not have input devices 218. Instead, fine-tuning server 110 may receive equivalent input information by receiving commands in the form of messages transmitted over a network and received via network adapter 230. In some embodiments, switch 226 is configured to provide connections between I/O bridge 220 and other components of fine-tuning server 110, such as a network adapter 230 and various add-in cards 224 and 228.

In some embodiments, I/O bridge 220 is coupled to a system disk 222 that may be configured to store content and applications and data for use by processor 112 and parallel processing subsystem 212. In some embodiments, system disk 222 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 220 as well.

In various embodiments, memory bridge 214 may be a Northbridge chip, and I/O bridge 220 may be a Southbridge chip. In addition, communication paths 213 and 207, as well as other communication paths within fine-tuning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 216 that may be any conventional cathode ray tube, liquid crystal display, light-emitting diode display, or the like. In such embodiments, parallel processing subsystem 212 incorporates circuitry optimized for graphics and video processing, including, for example, video output circuitry. Such circuitry may be incorporated across one or more parallel processing units (PPUs), also referred to herein as parallel processors, included within parallel processing subsystem 212. In other embodiments, parallel processing subsystem 212 incorporates circuitry optimized for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and compute processing operations. System memory 114 includes at least one device driver configured to manage the processing operations of the one or more PPUs within parallel processing subsystem 212.

In addition, system memory 114 includes re-training application 116 and trained VLM 118. As described, re-training application 116 is configured to re-train a trained VLM, such as trained VLM 118, using training data. Although described herein primarily with respect to re-training application 116, techniques disclosed herein can also be implemented, either entirely or in part, in other software and/or hardware, such as in parallel processing subsystem 212.

In various embodiments, parallel processing subsystem 212 may be integrated with one or more of the other elements of FIG. 2 to form a single system. For example, parallel processing subsystem 212 may be integrated with processor 112 and other connection circuitry on a single chip to form a system on chip (SoC).

In some embodiments, processor 112 is the master processor of fine-tuning server 110, controlling and coordinating operations of other system components. In some embodiments, processor 112 issues commands that control the operation of PPUs. In some embodiments, communication path 213 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of processors 112, and the number of parallel processing subsystems 212, may be modified as desired. For example, in some embodiments, system memory 114 could be connected to processor 112 directly rather than through memory bridge 214, and other devices would communicate with system memory 114 via memory bridge 214 and processor 112. In other embodiments, parallel processing subsystem 212 may be connected to I/O bridge 220 or directly to processor 112, rather than to memory bridge 214. In still other embodiments, I/O bridge 220 and memory bridge 214 may be integrated into a single chip instead of existing as one or more discrete devices. In certain embodiments, one or more components shown in FIG. 2 may not be present. For example, switch 226 could be eliminated, and network adapter 230 and add-in cards 224, 228 would connect directly to I/O bridge 220. Lastly, in certain embodiments, one or more components shown in FIG. 2 may be implemented as virtualized resources in a virtual computing environment, such as a cloud computing environment. In particular, parallel processing subsystem 212 may be implemented as a virtualized parallel processing subsystem in some embodiments. For example, parallel processing subsystem 212 could be implemented as a virtual graphics processing unit (GPU) that renders graphics on a virtual machine (VM) executing on a server machine whose GPU and other physical resources are shared across multiple VMs.

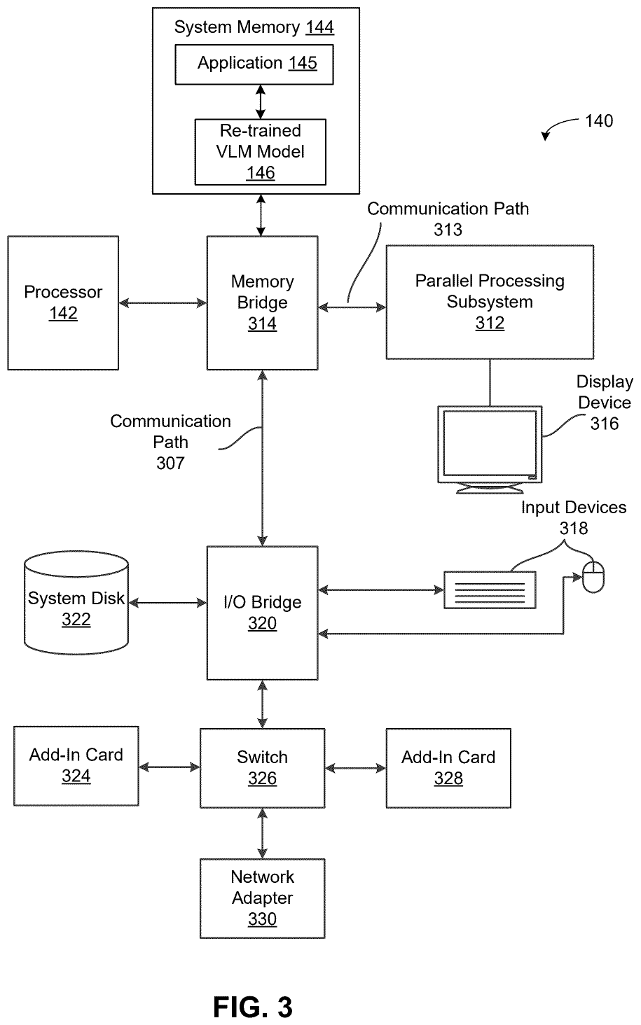

FIG. 3 is a more detailed illustration of computing device 140 of FIG. 1, according to various embodiments. As persons skilled in the art will appreciate, computing device 140 can be any type of technically feasible computer system, including, without limitation, a server machine, a server platform, a desktop machine, laptop machine, a hand-held/mobile device, or a wearable device. In some embodiments, computing device 140 is a server machine operating in a data center or a cloud computing environment that provides scalable computing resources as a service over a network.

In various embodiments, computing device 140 includes, without limitation, a processor 142 and a memory 144 coupled to a parallel processing subsystem 312 via a memory bridge 314 and a communication path 313. Memory bridge 314 is further coupled to an I/O (input/output) bridge 320 via a communication path 307, and I/O bridge 220 is, in turn, coupled to a switch 326.

In some embodiments, I/O bridge 320 is configured to receive user input information from optional input devices 318, such as a keyboard or a mouse, and forward the input information to processor 142 for processing via communication path 313 and memory bridge 314. In some embodiments, computing device 140 may be a server machine in a cloud computing environment. In such embodiments, computing device 140 may not have input devices 318. Instead, computing device 140 may receive equivalent input information by receiving commands in the form of messages transmitted over a network and received via network adapter 330. In some embodiments, switch 326 is configured to provide connections between I/O bridge 320 and other components of computing device 140, such as a network adapter 330 and various add-in cards 324 and 328.

In some embodiments, I/O bridge 320 is coupled to a system disk 322 that may be configured to store content and applications and data for use by processor 142 and parallel processing subsystem 312. In some embodiments, system disk 322 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 320 as well.

In various embodiments, memory bridge 314 may be a Northbridge chip, and I/O bridge 320 may be a Southbridge chip. In addition, communication paths 313 and 207, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 312 comprises a graphics subsystem that delivers pixels to an optional display device 316 that may be any conventional cathode ray tube, liquid crystal display, light-emitting diode display, or the like. In such embodiments, parallel processing subsystem 312 incorporates circuitry optimized for graphics and video processing, including, for example, video output circuitry. Such circuitry may be incorporated across one or more parallel processing units (PPUs), also referred to herein as parallel processors, included within parallel processing subsystem 312. In other embodiments, parallel processing subsystem 312 incorporates circuitry optimized for general purpose and/or compute processing. Again, such circuitry may be incorporated across one or more PPUs included within parallel processing subsystem 312 that are configured to perform such general purpose and/or compute operations. In yet other embodiments, the one or more PPUs included within parallel processing subsystem 312 may be configured to perform graphics processing, general purpose processing, and compute processing operations. System memory 144 includes at least one device driver configured to manage the processing operations of the one or more PPUs within parallel processing subsystem 312.

In addition, system memory 144 includes AV application 145 and re-trained VLM 146. In some embodiments, AV application 145 receives sensor data, generates a plan for a vehicle (e.g., the autonomous vehicle 400 described below in conjunction with FIGS. 4A-4D) to follow, and uses re-trained VLM 146 to choose between the plan or an alternative plan that reduces risk. AV application 145 controls the vehicle to steer, accelerate, and brake according to the selected plan. Although described herein primarily with respect to AV application 145, techniques disclosed herein can also be implemented, either entirely or in part, in other software and/or hardware, such as in parallel processing subsystem 312.

In various embodiments, parallel processing subsystem 312 may be integrated with one or more of the other elements of FIG. 3 to form a single system. For example, parallel processing subsystem 312 may be integrated with processor 142 and other connection circuitry on a single chip to form a system on chip (SoC).

In some embodiments, processor 142 is the master processor of computing device 140, controlling and coordinating operations of other system components. In some embodiments, processor 142 issues commands that control the operation of PPUs. In some embodiments, communication path 313 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of processors 142, and the number of parallel processing subsystems 312, may be modified as desired. For example, in some embodiments, system memory 144 could be connected to processor 142 directly rather than through memory bridge 314, and other devices would communicate with system memory 144 via memory bridge 314 and processor 142. In other embodiments, parallel processing subsystem 312 may be connected to I/O bridge 320 or directly to processor 142, rather than to memory bridge 314. In still other embodiments, I/O bridge 320 and memory bridge 314 may be integrated into a single chip instead of existing as one or more discrete devices. In certain embodiments, one or more components shown in FIG. 3 may not be present. For example, switch 326 could be eliminated, and network adapter 330 and add-in cards 324, 328 would connect directly to I/O bridge 320. Lastly, in certain embodiments, one or more components shown in FIG. 3 may be implemented as virtualized resources in a virtual computing environment, such as a cloud computing environment. In particular, parallel processing subsystem 312 may be implemented as a virtualized parallel processing subsystem in some embodiments. For example, parallel processing subsystem 312 could be implemented as a virtual graphics processing unit (GPU) that renders graphics on a virtual machine (VM) executing on a server machine whose GPU and other physical resources are shared across multiple VMs.

### Example Autonomous Vehicle

FIG. 4A is an illustration of an exemplar autonomous vehicle 400, according to various embodiments. The autonomous vehicle 400 (alternatively referred to herein as the “vehicle 400”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-401806, published on Jun. 15, 4018, Standard No. J3016-401609, published on Sep. 30, 4016, and previous and future versions of this standard). The vehicle 400 may be capable of functionality in accordance with one or more of Level 3-Level 5 of the autonomous driving levels. The vehicle 400 may be capable of functionality in accordance with one or more of Level 1-Level 5 of the autonomous driving levels. For example, the vehicle 400 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 400 or other machine, such as being fully autonomous, being highly autonomous, being conditionally autonomous, being partially autonomous, providing assistive autonomy, being semi-autonomous, being primarily autonomous, or other designation.

The vehicle 400 may include components such as a chassis, a vehicle body, wheels (e.g., 2, 4, 6, 8, 18, etc.), tires, axles, and other components of a vehicle. The vehicle 400 may include a propulsion system 450, such as an internal combustion engine, hybrid electric power plant, an all-electric engine, and/or another propulsion system type. The propulsion system 450 may be connected to a drive train of the vehicle 400, which may include a transmission, to enable the propulsion of the vehicle 400. The propulsion system 450 may be controlled in response to receiving signals from the throttle/accelerator 452.

A steering system 454, which may include a steering wheel, may be used to steer the vehicle 400 (e.g., along a desired path or route) when the propulsion system 450 is operating (e.g., when the vehicle is in motion). The steering system 454 may receive signals from a steering actuator 456. The steering wheel may be optional for full automation (Level 5) functionality.

The brake sensor system 446 may be used to operate the vehicle brakes in response to receiving signals from the brake actuators 448 and/or brake sensors.

Controller(s) 436, which may include one or more system on chips (SoCs) 404 (FIG. 4C) and/or GPU(s), may provide signals (e.g., representative of commands) to one or more components and/or systems of the vehicle 400. For example, the controller(s) may send signals to operate the vehicle brakes via one or more brake actuators 448, to operate the steering system 454 via one or more steering actuators 456, to operate the propulsion system 450 via one or more throttle/accelerators 452. The controller(s) 436 may include one or more onboard (e.g., integrated) computing devices (e.g., supercomputers) that process sensor signals, and output operation commands (e.g., signals representing commands) to enable autonomous driving and/or to assist a human driver in driving the vehicle 400. The controller(s) 436 may include a first controller 436 for autonomous driving functions, a second controller 436 for functional safety functions, a third controller 436 for artificial intelligence functionality (e.g., computer vision), a fourth controller 436 for infotainment functionality, a fifth controller 436 for redundancy in emergency conditions, and/or other controllers. In some examples, a single controller 436 may handle two or more of the above functionalities, two or more controllers 436 may handle a single functionality, and/or any combination thereof.

The controller(s) 436 may provide the signals for controlling one or more components and/or systems of the vehicle 400 in response to sensor data received from one or more sensors (e.g., sensor inputs). The sensor data may be received from, for example and without limitation, global navigation satellite systems (“GNSS”) sensor(s) 458 (e.g., Global Positioning System sensor(s)), RADAR sensor(s) 460, ultrasonic sensor(s) 462, LIDAR sensor(s) 464, inertial measurement unit (IMU) sensor(s) 466 (e.g., accelerometer(s), gyroscope(s), magnetic compass(es), magnetometer(s), etc.), microphone(s) 496, stereo camera(s) 468, wide-view camera(s) 470 (e.g., fisheye cameras), infrared camera(s) 472, surround camera(s) 474 (e.g., 360 degree cameras), long-range and/or mid-range camera(s) 498, speed sensor(s) 444 (e.g., for measuring the speed of the vehicle 400), vibration sensor(s) 442, steering sensor(s) 440, brake sensor(s) (e.g., as part of the brake sensor system 446), and/or other sensor types.

One or more of the controller(s) 436 may receive inputs (e.g., represented by input data) from an instrument cluster 432 of the vehicle 400 and provide outputs (e.g., represented by output data, display data, etc.) via a human-machine interface (HMI) display 434, an audible annunciator, a loudspeaker, and/or via other components of the vehicle 400. The outputs may include information such as vehicle velocity, speed, time, map data (e.g., the High Definition (“HD”) map 422 of FIG. 4C), location data (e.g., the vehicle's 400 location, such as on a map), direction, location of other vehicles (e.g., an occupancy grid), information about objects and status of objects as perceived by the controller(s) 436, etc. For example, the HMI display 434 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 400 further includes a network interface 424 which may use one or more wireless antenna(s) 426 and/or modem(s) to communicate over one or more networks. For example, the network interface 424 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA4000”), etc. The wireless antenna(s) 426 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 4B illustrates exemplar camera locations and fields of view for the exemplar autonomous vehicle 400 of FIG. 4A, according to various embodiments. The cameras and respective fields of view are one example embodiment and are not intended to be limiting. For example, additional and/or alternative cameras may be included and/or the cameras may be located at different locations on the vehicle 400.

The camera types for the cameras may include, but are not limited to, digital cameras that may be adapted for use with the components and/or systems of the vehicle 400. The camera(s) may operate at automotive safety integrity level (ASIL) B and/or at another ASIL. The camera types may be capable of any image capture rate, such as 60 frames per second (fps), 120 fps, 440 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 400 (e.g., front-facing cameras) may be used for surround view, to help identify forward facing paths and obstacles, as well aid in, with the help of one or more controllers 436 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 470 that may be used to perceive objects coming into view from the periphery (e.g., pedestrians, crossing traffic or bicycles). Although only one wide-view camera is illustrated in FIG. 4B, there may be any number (including zero) of wide-view cameras 470 on the vehicle 400. In addition, any number of long-range camera(s) 498 (e.g., a long-view stereo camera pair) may be used for depth-based object detection, especially for objects for which a neural network has not yet been trained. The long-range camera(s) 498 may also be used for object detection and classification, as well as basic object tracking.

Any number of stereo cameras 468 may also be included in a front-facing configuration. In some embodiments, one or more of stereo camera(s) 468 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 468 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 468 may be used in addition to, or alternatively from, those described herein.

Cameras with a field of view that include portions of the environment to the side of the vehicle 400 (e.g., side-view cameras) may be used for surround view, providing information used to create and update the occupancy grid, as well as to generate side impact collision warnings. For example, surround camera(s) 474 (e.g., four surround cameras 474 as illustrated in FIG. 4B) may be positioned on the vehicle 400. The surround camera(s) 474 may include wide-view camera(s) 470, fisheye camera(s), 360 degree camera(s), and/or the like. Four example, four fisheye cameras may be positioned on the vehicle's front, rear, and sides. In an alternative arrangement, the vehicle may use three surround camera(s) 474 (e.g., left, right, and rear), and may leverage one or more other camera(s) (e.g., a forward-facing camera) as a fourth surround view camera.

Cameras with a field of view that include portions of the environment to the rear of the vehicle 400 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 498, stereo camera(s) 468), infrared camera(s) 472, etc.), as described herein.

FIG. 4C is a block diagram of an exemplar system architecture for the exemplar autonomous vehicle 400 of FIG. 4A, according to various embodiments. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 400 in FIG. 4C are illustrated as being connected via bus 402. The bus 402 may include a Controller Area Network (CAN) data interface (alternatively referred to herein as a “CAN bus”). A CAN may be a network inside the vehicle 400 used to aid in control of various features and functionality of the vehicle 400, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 402 is described herein as being a CAN bus, this is not intended to be limiting. For example, in addition to, or alternatively from, the CAN bus, FlexRay and/or Ethernet may be used. Additionally, although a single line is used to represent the bus 402, this is not intended to be limiting. For example, there may be any number of busses 402, which may include one or more CAN busses, one or more FlexRay busses, one or more Ethernet busses, and/or one or more other types of busses using a different protocol. In some examples, two or more busses 402 may be used to perform different functions, and/or may be used for redundancy. For example, a first bus 402 may be used for collision avoidance functionality and a second bus 402 may be used for actuation control. In any example, each bus 402 may communicate with any of the components of the vehicle 400, and two or more busses 402 may communicate with the same components. In some examples, each SoC 404, each controller 436, and/or each computer within the vehicle may have access to the same input data (e.g., inputs from sensors of the vehicle 400), and may be connected to a common bus, such the CAN bus.

The vehicle 400 may include one or more controller(s) 436, such as those described herein with respect to FIG. 4A. The controller(s) 436 may be used for a variety of functions. The controller(s) 436 may be coupled to any of the various other components and systems of the vehicle 400, and may be used for control of the vehicle 400, artificial intelligence of the vehicle 400, infotainment for the vehicle 400, and/or the like.

The vehicle 400 may include a system(s) on a chip (SoC) 404. The SoC 404 may include CPU(s) 406, GPU(s) 408, processor(s) 410, cache(s) 412, accelerator(s) 414, data store(s) 416, and/or other components and features not illustrated. In some embodiments, components (e.g., CPU(s) 410 and data store(s) 416) included in the vehicle 400 can be the same as, or similar to, corresponding components (e.g., processor(s) 142 and memory (ies) 144) included in the computing system 140, described above in conjunction with FIG. 1. The SoC(s) 404 may be used to control the vehicle 400 in a variety of platforms and systems. For example, the SoC(s) 404 may be combined in a system (e.g., the system of the vehicle 400) with an HD map 422 which may obtain map refreshes and/or updates via a network interface 424 from one or more servers (e.g., server(s) 478 of FIG. 4D).

The CPU(s) 406 may include a CPU cluster or CPU complex (alternatively referred to herein as a “CCPLEX”). The CPU(s) 406 may include multiple cores and/or L2 caches. For example, in some embodiments, the CPU(s) 406 may include eight cores in a coherent multi-processor configuration. In some embodiments, the CPU(s) 406 may include four dual-core clusters where each cluster has a dedicated L2 cache (e.g., a 2 MB L2 cache). The CPU(s) 406 (e.g., the CCPLEX) may be configured to support simultaneous cluster operation enabling any combination of the clusters of the CPU(s) 406 to be active at any given time.

The CPU(s) 406 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 406 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 408 may include an integrated GPU (alternatively referred to herein as an “iGPU”). The GPU(s) 408 may be programmable and may be efficient for parallel workloads. The GPU(s) 408, in some examples, may use an enhanced tensor instruction set. The GPU(s) 408 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 408 may include at least eight streaming microprocessors. The GPU(s) 408 may use compute application programming interface(s) (API(s)). In addition, the GPU(s) 408 may use one or more parallel computing platforms and/or programming models (e.g., NVIDIA's CUDA).

The GPU(s) 408 may be power-optimized for best performance in automotive and embedded use cases. For example, the GPU(s) 408 may be fabricated on a Fin field-effect transistor (FinFET). However, this is not intended to be limiting and the GPU(s) 408 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 408 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 408 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 408 to access the CPU(s) 406 page tables directly. In such examples, when the GPU(s) 408 memory management unit (MMU) experiences a miss, an address translation request may be transmitted to the CPU(s) 406. In response, the CPU(s) 406 may look in its page tables for the virtual-to-physical mapping for the address and transmits the translation back to the GPU(s) 408. As such, unified memory technology may allow a single unified virtual address space for memory of both the CPU(s) 406 and the GPU(s) 408, thereby simplifying the GPU(s) 408 programming and porting of applications to the GPU(s) 408.

In addition, the GPU(s) 408 may include an access counter that may keep track of the frequency of access of the GPU(s) 408 to memory of other processors. The access counter may help ensure that memory pages are moved to the physical memory of the processor that is accessing the pages most frequently.

The SoC(s) 404 may include any number of cache(s) 412, including those described herein. For example, the cache(s) 412 may include an L3 cache that is available to both the CPU(s) 406 and the GPU(s) 408 (e.g., that is connected both the CPU(s) 406 and the GPU(s) 408). The cache(s) 412 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 404 may include an arithmetic logic unit(s) (ALU(s)) which may be leveraged in performing processing with respect to any of the variety of tasks or operations of the vehicle 400—such as processing DNNs. In addition, the SoC(s) 404 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 406 and/or GPU(s) 408.

The SoC(s) 404 may include one or more accelerators 414 (e.g., hardware accelerators, software accelerators, or a combination thereof). For example, the SoC(s) 404 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 408 and to off-load some of the tasks of the GPU(s) 408 (e.g., to free up more cycles of the GPU(s) 408 for performing other tasks). As an example, the accelerator(s) 414 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 414 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 408, and by using an inference accelerator, for example, a designer may target either the DLA(s) or the GPU(s) 408 for any function. For example, the designer may focus processing of CNNs and floating point operations on the DLA(s) and leave other functions to the GPU(s) 408 and/or other accelerator(s) 414.

The accelerator(s) 414 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 406. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 414 (e.g., the hardware acceleration cluster) may include a computer vision network on-chip and SRAM, for providing a high-bandwidth, low latency SRAM for the accelerator(s) 414. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 46262 or IEC 61508 standards, although other standards and protocols may be used.

In some examples, the SoC(s) 404 may include a real-time ray-tracing hardware accelerator, such as described in U.S. patent application Ser. No. 16/101,432, filed on Aug. 10, 4018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 414 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 466 output that correlates with the vehicle 400 orientation, distance, 3D location estimates of the object obtained from the neural network and/or other sensors (e.g., LIDAR sensor(s) 464 or RADAR sensor(s) 460), among others.

The SoC(s) 404 may include data store(s) 416 (e.g., memory). The data store(s) 416 may be on-chip memory of the SoC(s) 404, which may store neural networks to be executed on the GPU and/or the DLA. In some examples, the data store(s) 416 may be large enough in capacity to store multiple instances of neural networks for redundancy and safety. The data store(s) 412 may comprise L2 or L3 cache(s) 412. Reference to the data store(s) 416 may include reference to the memory associated with the PVA, DLA, and/or other accelerator(s) 414, as described herein.

The SoC(s) 404 may include one or more processor(s) 410 (e.g., embedded processors). The processor(s) 410 may include a boot and power management processor that may be a dedicated processor and subsystem to handle boot power and management functions and related security enforcement. The boot and power management processor may be a part of the SoC(s) 404 boot sequence and may provide runtime power management services. The boot power and management processor may provide clock and voltage programming, assistance in system low power state transitions, management of SoC(s) 404 thermals and temperature sensors, and/or management of the SoC(s) 404 power states. Each temperature sensor may be implemented as a ring-oscillator whose output frequency is proportional to temperature, and the SoC(s) 404 may use the ring-oscillators to detect temperatures of the CPU(s) 406, GPU(s) 408, and/or accelerator(s) 414. If temperatures are determined to exceed a threshold, the boot and power management processor may enter a temperature fault routine and put the SoC(s) 404 into a lower power state and/or put the vehicle 400 into a chauffeur to safe stop mode (e.g., bring the vehicle 400 to a safe stop).

The processor(s) 410 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 410 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 410 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 410 may further include a real-time camera engine that may include a dedicated processor subsystem for handling real-time camera management.

The processor(s) 410 may further include a high-dynamic range signal processor that may include an image signal processor that is a hardware engine that is part of the camera processing pipeline.

The processor(s) 410 may include a video image compositor that may be a processing block (e.g., implemented on a microprocessor) that implements video post-processing functions needed by a video playback application to produce the final image for the player window. The video image compositor may perform lens distortion correction on wide-view camera(s) 470, surround camera(s) 474, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 408 is not required to continuously render new surfaces. Even when the GPU(s) 408 is powered on and active doing 3D rendering, the video image compositor may be used to offload the GPU(s) 408 to improve performance and responsiveness.

The SoC(s) 404 may further include a mobile industry processor interface (MIPI) camera serial interface for receiving video and input from cameras, a high-speed interface, and/or a video input block that may be used for camera and related pixel input functions. The SoC(s) 404 may further include an input/output controller(s) that may be controlled by software and may be used for receiving I/O signals that are uncommitted to a specific role.

The SoC(s) 404 may further include a broad range of peripheral interfaces to enable communication with peripherals, audio codecs, power management, and/or other devices. The SoC(s) 404 may be used to process data from cameras (e.g., connected over Gigabit Multimedia Serial Link and Ethernet), sensors (e.g., LIDAR sensor(s) 464, RADAR sensor(s) 460, etc. that may be connected over Ethernet), data from bus 402 (e.g., speed of vehicle 400, steering wheel position, etc.), data from GNSS sensor(s) 458 (e.g., connected over Ethernet or CAN bus). The SoC(s) 404 may further include dedicated high-performance mass storage controllers that may include their own DMA engines, and that may be used to free the CPU(s) 406 from routine data management tasks.

The SoC(s) 404 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 404 may be faster, more reliable, and even more energy-efficient and space-efficient than conventional systems. For example, the accelerator(s) 414, when combined with the CPU(s) 406, the GPU(s) 408, and the data store(s) 416, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 420) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 408.

In some examples, a CNN for facial recognition and vehicle owner identification may use data from camera sensors to identify the presence of an authorized driver and/or owner of the vehicle 400. The always on sensor processing engine may be used to unlock the vehicle when the owner approaches the driver door and turn on the lights, and, in security mode, to disable the vehicle when the owner leaves the vehicle. In this way, the SoC(s) 404 provide for security against theft and/or carjacking.

In another example, a CNN for emergency vehicle detection and identification may use data from microphones 496 to detect and identify emergency vehicle sirens. In contrast to conventional systems, that use general classifiers to detect sirens and manually extract features, the SoC(s) 404 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 458. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 462, until the emergency vehicle(s) passes.

The vehicle may include a CPU(s) 418 (e.g., discrete CPU(s), or dCPU(s)), that may be coupled to the SoC(s) 404 via a high-speed interconnect (e.g., PCIe). The CPU(s) 418 may include an X86 processor, for example. The CPU(s) 418 may be used to perform any of a variety of functions, including arbitrating potentially inconsistent results between ADAS sensors and the SoC(s) 404, and/or monitoring the status and health of the controller(s) 436 and/or infotainment SoC 430, for example.

The vehicle 400 may include a GPU(s) 420 (e.g., discrete GPU(s), or dGPU(s)), that may be coupled to the SoC(s) 404 via a high-speed interconnect (e.g., NVIDIA's NVLINK). The GPU(s) 420 may provide additional artificial intelligence functionality, such as by executing redundant and/or different neural networks, and may be used to train and/or update neural networks based on input (e.g., sensor data) from sensors of the vehicle 400.

The vehicle 400 may further include the network interface 424 which may include one or more wireless antennas 426 (e.g., one or more wireless antennas for different communication protocols, such as a cellular antenna, a Bluetooth antenna, etc.). The network interface 424 may be used to enable wireless connectivity over the Internet with the cloud (e.g., with the server(s) 478 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 400 information about vehicles in proximity to the vehicle 400 (e.g., vehicles in front of, on the side of, and/or behind the vehicle 400). This functionality may be part of a cooperative adaptive cruise control functionality of the vehicle 400.

The network interface 424 may include a SoC that provides modulation and demodulation functionality and enables the controller(s) 436 to communicate over wireless networks. The network interface 424 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA4000, Bluetooth, Bluetooth LE, Wi-Fi, Z-Wave, ZigBee, LoRaWAN, and/or other wireless protocols.

The vehicle 400 may further include data store(s) 428 which may include off-chip (e.g., off the SoC(s) 404) storage. The data store(s) 428 may include one or more storage elements including RAM, SRAM, DRAM, VRAM, Flash, hard disks, and/or other components and/or devices that may store at least one bit of data.

The vehicle 400 may further include GNSS sensor(s) 458. The GNSS sensor(s) 458 (e.g., GPS, assisted GPS sensors, differential GPS (DGPS) sensors, etc.), to assist in mapping, perception, occupancy grid generation, and/or path planning functions. Any number of GNSS sensor(s) 458 may be used, including, for example and without limitation, a GPS using a USB connector with an Ethernet to Serial (RS-432) bridge.

The vehicle 400 may further include RADAR sensor(s) 460. The RADAR sensor(s) 460 may be used by the vehicle 400 for long-range vehicle detection, even in darkness and/or severe weather conditions. RADAR functional safety levels may be ASIL B. The RADAR sensor(s) 460 may use the CAN and/or the bus 402 (e.g., to transmit data generated by the RADAR sensor(s) 460) for control and to access object tracking data, with access to Ethernet to access raw data in some examples. A wide variety of RADAR sensor types may be used. For example, and without limitation, the RADAR sensor(s) 460 may be suitable for front, rear, and side RADAR use. In some example, Pulse Doppler RADAR sensor(s) are used.

The RADAR sensor(s) 460 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 450 m range. The RADAR sensor(s) 460 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 400 surroundings at higher speeds with minimal interference from traffic in adjacent lanes. The other two antennae may expand the field of view, making it possible to quickly detect vehicles entering or leaving the vehicle's 400 lane.

Mid-range RADAR systems may include, as an example, a range of up to 460 m (front) or 80 m (rear), and a field of view of up to 42 degrees (front) or 450 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 400 may further include ultrasonic sensor(s) 462. The ultrasonic sensor(s) 462, which may be positioned at the front, back, and/or the sides of the vehicle 400, may be used for park assist and/or to create and update an occupancy grid. A wide variety of ultrasonic sensor(s) 462 may be used, and different ultrasonic sensor(s) 462 may be used for different ranges of detection (e.g., 2.5 m, 4 m). The ultrasonic sensor(s) 462 may operate at functional safety levels of ASIL B.

The vehicle 400 may include LIDAR sensor(s) 464. The LIDAR sensor(s) 464 may be used for object and pedestrian detection, emergency braking, collision avoidance, and/or other functions. The LIDAR sensor(s) 464 may be functional safety level ASIL B. In some examples, the vehicle 400 may include multiple LIDAR sensors 464 (e.g., two, four, six, etc.) that may use Ethernet (e.g., to provide data to a Gigabit Ethernet switch).

In some examples, the LIDAR sensor(s) 464 may be capable of providing a list of objects and their distances for a 360-degree field of view. Commercially available LIDAR sensor(s) 464 may have an advertised range of approximately 400 m, with an accuracy of 2 cm-3 cm, and with support for a 400 Mbps Ethernet connection, for example. In some examples, one or more non-protruding LIDAR sensors 464 may be used. In such examples, the LIDAR sensor(s) 464 may be implemented as a small device that may be embedded into the front, rear, sides, and/or corners of the vehicle 400. The LIDAR sensor(s) 464, in such examples, may provide up to a 120-degree horizontal and 35-degree vertical field-of-view, with a 400 m range even for low-reflectivity objects. Front-mounted LIDAR sensor(s) 464 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 400 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 400. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 464 may be less susceptible to motion blur, vibration, and/or shock.

The vehicle may further include IMU sensor(s) 466. The IMU sensor(s) 466 may be located at a center of the rear axle of the vehicle 400, in some examples. The IMU sensor(s) 466 may include, for example and without limitation, an accelerometer(s), a magnetometer(s), a gyroscope(s), a magnetic compass(es), and/or other sensor types. In some examples, such as in six-axis applications, the IMU sensor(s) 466 may include accelerometers and gyroscopes, while in nine-axis applications, the IMU sensor(s) 466 may include accelerometers, gyroscopes, and magnetometers.

In some embodiments, the IMU sensor(s) 466 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 466 may enable the vehicle 400 to estimate heading without requiring input from a magnetic sensor by directly observing and correlating the changes in velocity from GPS to the IMU sensor(s) 466. In some examples, the IMU sensor(s) 466 and the GNSS sensor(s) 458 may be combined in a single integrated unit.

The vehicle may include microphone(s) 496 placed in and/or around the vehicle 400. The microphone(s) 496 may be used for emergency vehicle detection and identification, among other things.

The vehicle may further include any number of camera types, including stereo camera(s) 468, wide-view camera(s) 470, infrared camera(s) 472, surround camera(s) 474, long-range and/or mid-range camera(s) 498, and/or other camera types. The cameras may be used to capture image data around an entire periphery of the vehicle 400. The types of cameras used depends on the embodiments and requirements for the vehicle 400, and any combination of camera types may be used to provide the necessary coverage around the vehicle 400. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 4A and FIG. 4B.

The vehicle 400 may further include vibration sensor(s) 442. The vibration sensor(s) 442 may measure vibrations of components of the vehicle, such as the axle(s). For example, changes in vibrations may indicate a change in road surfaces. In another example, when two or more vibration sensors 442 are used, the differences between the vibrations may be used to determine friction or slippage of the road surface (e.g., when the difference in vibration is between a power-driven axle and a freely rotating axle).

The vehicle 400 may include an ADAS system 438. The ADAS system 438 may include a SoC, in some examples. The ADAS system 438 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 460, LIDAR sensor(s) 464, and/or a camera(s). The ACC systems may include longitudinal ACC and/or lateral ACC. Longitudinal ACC monitors and controls the distance to the vehicle immediately ahead of the vehicle 400 and automatically adjust the vehicle speed to maintain a safe distance from vehicles ahead. Lateral ACC performs distance keeping, and advises the vehicle 400 to change lanes when necessary. Lateral ACC is related to other ADAS applications such as LCA and CWS.

CACC uses information from other vehicles that may be received via the network interface 424 and/or the wireless antenna(s) 426 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 400), while the 12V communication concept provides information about traffic further ahead. CACC systems may include either or both 12V and V2V information sources. Given the information of the vehicles ahead of the vehicle 400, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 460, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 460, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 400 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 400 if the vehicle 400 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 460, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 400 is backing up. Some RCTW systems include AEB to ensure that the vehicle brakes are applied to avoid a crash. RCTW systems may use one or more rear-facing RADAR sensor(s) 460, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 400, the vehicle 400 itself must, in the case of conflicting results, decide whether to heed the result from a primary computer or a secondary computer (e.g., a first controller 436 or a second controller 436). For example, in some embodiments, the ADAS system 438 may be a backup and/or secondary computer for providing perception information to a backup computer rationality module. The backup computer rationality monitor may run a redundant diverse software on hardware components to detect faults in perception and dynamic driving tasks. Outputs from the ADAS system 438 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 404.

In other examples, ADAS system 438 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 438 may be fed into the primary computer's perception block and/or the primary computer's dynamic driving task block. For example, if the ADAS system 438 indicates a forward crash warning due to an object immediately ahead, the perception block may use this information when identifying objects. In other examples, the secondary computer may have its own neural network which is trained and thus reduces the risk of false positives, as described herein.

The vehicle 400 may further include the infotainment SoC 430 (e.g., an in-vehicle infotainment system (IVI)). Although illustrated and described as a SoC, the infotainment system may not be a SoC, and may include two or more discrete components. The infotainment SoC 430 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 400. For example, the infotainment SoC 430 may radios, disk players, navigation systems, video players, USB and Bluetooth connectivity, carputers, in-car entertainment, Wi-Fi, steering wheel audio controls, hands free voice control, a heads-up display (HUD), an HMI display 434, a telematics device, a control panel (e.g., for controlling and/or interacting with various components, features, and/or systems), and/or other components. The infotainment SoC 430 may further be used to provide information (e.g., visual and/or audible) to a user(s) of the vehicle, such as information from the ADAS system 438, autonomous driving information such as planned vehicle maneuvers, trajectories, surrounding environment information (e.g., intersection information, vehicle information, road information, etc.), and/or other information.

The infotainment SoC 430 may include GPU functionality. The infotainment SoC 430 may communicate over the bus 402 (e.g., CAN bus, Ethernet, etc.) with other devices, systems, and/or components of the vehicle 400. In some examples, the infotainment SoC 430 may be coupled to a supervisory MCU such that the GPU of the infotainment system may perform some self-driving functions in the event that the primary controller(s) 436 (e.g., the primary and/or backup computers of the vehicle 400) fail. In such an example, the infotainment SoC 430 may put the vehicle 400 into a chauffeur to safe stop mode, as described herein.

The vehicle 400 may further include an instrument cluster 432 (e.g., a digital dash, an electronic instrument cluster, a digital instrument panel, etc.). The instrument cluster 432 may include a controller and/or supercomputer (e.g., a discrete controller or supercomputer). The instrument cluster 432 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 430 and the instrument cluster 432. In other words, the instrument cluster 432 may be included as part of the infotainment SoC 430, or vice versa.

FIG. 4D is a system diagram for communication between cloud-based server(s) and the exemplar autonomous vehicle 400 of FIG. 4A, according to various embodiments. The system 476 may include server(s) 478, network(s) 490, and vehicles, including the vehicle 400. The server(s) 478 may include a plurality of GPUs 484(A)-484(H) (collectively referred to herein as GPUs 484), PCIe switches 482(A)-482(H) (collectively referred to herein as PCIe switches 482), and/or CPUs 480(A)-480(B) (collectively referred to herein as CPUs 480). The GPUs 484, the CPUs 480, and the PCIe switches may be interconnected with high-speed interconnects such as, for example and without limitation, NVLink interfaces 488 developed by NVIDIA and/or PCIe connections 486. In some examples, the GPUs 484 are connected via NVLink and/or NVSwitch SoC and the GPUs 484 and the PCIe switches 482 are connected via PCIe interconnects. Although eight GPUs 484, two CPUs 480, and two PCIe switches are illustrated, this is not intended to be limiting. Depending on the embodiment, each of the server(s) 478 may include any number of GPUs 484, CPUs 480, and/or PCIe switches. For example, the server(s) 478 may each include eight, sixteen, thirty-two, and/or more GPUs 484.

The server(s) 478 may receive, over the network(s) 490 and from the vehicles, image data representative of images showing unexpected or changed road conditions, such as recently commenced road-work. The server(s) 478 may transmit, over the network(s) 490 and to the vehicles, neural networks 492, updated neural networks 492, and/or map information 494, including information regarding traffic and road conditions. The updates to the map information 494 may include updates for the HD map 422, such as information regarding construction sites, potholes, detours, flooding, and/or other obstructions. In some examples, the neural networks 492, the updated neural networks 492, and/or the map information 494 may have resulted from new training and/or experiences represented in data received from any number of vehicles in the environment, and/or based on training performed at a datacenter (e.g., using the server(s) 478 and/or other servers).

The server(s) 478 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 490, and/or the machine learning models may be used by the server(s) 478 to remotely monitor the vehicles.

In some examples, the server(s) 478 may receive data from the vehicles and apply the data to up-to-date real-time neural networks for real-time intelligent inferencing. The server(s) 478 may include deep-learning supercomputers and/or dedicated AI computers powered by GPU(s) 484, such as a DGX and DGX Station machines developed by NVIDIA. However, in some examples, the server(s) 478 may include deep learning infrastructure that use only CPU-powered datacenters.

The deep-learning infrastructure of the server(s) 478 may be capable of fast, real-time inferencing, and may use that capability to evaluate and verify the health of the processors, software, and/or associated hardware in vehicle 400. For example, the deep-learning infrastructure may receive periodic updates from the vehicle 400, such as a sequence of images and/or objects that the vehicle 400 has located in that sequence of images (e.g., via computer vision and/or other machine learning object classification techniques). The deep-learning infrastructure may run its own neural network to identify the objects and compare them with the objects identified by the vehicle 400 and, if the results do not match and the infrastructure concludes that the AI in the vehicle 400 is malfunctioning, the server(s) 478 may transmit a signal to the vehicle 400 instructing a fail-safe computer of the vehicle 400 to assume control, notify the passengers, and complete a safe parking maneuver.

For inferencing, the server(s) 478 may include the GPU(s) 484 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Controlling Autonomous Vehicles Using Vision-Language Models

FIG. 5 is a more detailed illustration of re-training application 116 of FIG. 1, according to various embodiments. As shown, re-training application 116 includes, without limitation, an AV stack 510, auxiliary tools 520, and a re-training module 540. AV stack 510 includes, without limitation, a perception module 512 and a planner 516. Auxiliary tools 520 include, without limitation, a trajectory predictor 524, a traffic simulator 526, a collision checker 528, and a signal temporal logic (STL) module 529.

In operation, re-training application 116 receives sensor data 502, trained vision-language model (VLM) 118, and human-annotated labels 132 and/or generated labels 134 from data store 120. Re-training application 116 then performs re-training operations on trained VLM 118 using training data that includes human-annotated labels 132 and/or generated labels 134, in order to generate a re-trained VLM 146. Sensor data 502 includes any technically feasible data collected by sensors mounted on and/or within one or more vehicles. For example, sensor data 504 can include image data captured by cameras, LiDAR data, radar data, ultrasound sensor data, controller area network (CAN) bus data, and/or the like. In some other embodiments, a VLM can be trained from scratch using training data that includes the human-annotated labels 132 and/or generated labels 134.

AV stack 510 includes machine learning models and/or hand-crafted rules that enable a vehicle (e.g., vehicle 400) to drive autonomously. For example, AV stack 510 could include components to perceive the environment, make decisions, and control the vehicle. As shown, AV stack 510 receives sensor data 502 and generates a plan 518 to control the vehicle. Illustratively, AV stack 510 includes perception module 512 and planner 516. In some other embodiments, AV stack 510 can include a unified machine learning model that receives sensor data 502 and generates plan 518 and detections 514, without requiring separate perception and planner modules. In such embodiments, the unified machine learning model can be any feasible machine learning model, such as a Transformer-based neural network.

Perception module 512 can include any technically feasible machine learning model trained to process and understand the environment around the vehicle using data from various sensors, such as cameras, LiDAR, radar, and/or ultrasound sensors. Perception module 512 receives sensor data 502 and generates detections 514. Perception module 512 can use any suitable technique(s) to generate detections 514, such as object detection, object classification, segmentation, localization and/or tracking to generate detections 514.

Detections 514 can include detected objects, obstacles, or detected traffic signs, or boundaries and/or locations of such objects and traffic signs. For example, detections 514 can be the location and boundary of an incoming vehicle or a pedestrian crossing the road. Detections 514 can also include map related information such as lane markings, lane curvature, road classification, and road boundaries.

Planner 516 can include any machine learning model and/or rule-based system that takes as input detections 514 and generates a plan 518. Plan 518 then can be transmitted to a controller (not shown) that controls the steering, accelerating, and/or braking of the vehicle. In some embodiments, given detections 514, planner 516 can be a rule-based system that includes rules that are designed to control the vehicle and selected by a regression model. In some other embodiments, planner 516 can receive detections 514 as input and use one or more machine learning models to generate a plan 518. In some other embodiments, planner 516 can generate a sequence of plans executing one after each other. In some other embodiments, planner 516 can generate plan 518 by performing an optimization procedure that minimizes one or more hand-crafted cost functions with different criteria coming from detections 514.

Plan 518 can include coordinates defining a path of the vehicle. For example, the coordinates could be waypoints that form a trajectory. Plan 518 can be undesirable if the vehicle collides with an object, such as another vehicle or a pedestrian crossing, or the plan takes the vehicle off the road or violates traffic rules. Re-trained VLM 146 is trained to compute the risks associated with plan 518 or generate program code that can compute such risks, so that undesirable plans can be changed or replaced. When an undesirable plan is identified, a safe alternative plan can be executed instead. An example of a safe plan can be to slow down to a stop or other risk mitigating maneuvers when an incoming risk is detected.

Auxiliary tools 520 receive detections 514 and/or plan 518, which auxiliary tools 520 can process to understand the geometry of objects and/or physics. Any technically feasible auxiliary tools 520 that work on a geometric space, such as object-centric models, rather than sensor space, can be used in some embodiments. For example, auxiliary tools 520 could include tools that perform various simulations, compute the collision of the vehicle with obstacles, or compute a safe plan for navigating the vehicle. Examples of auxiliary tool 520 include trajectory predictor 524, traffic simulator 526, collision checker 528 and STL module 529. Trajectory predictor 524 receives detections 514 and generates future positions of surrounding objects, such as other vehicles, pedestrians, and/or cyclists. Traffic simulator 526 can simulate real-world simulations of traffic scenarios, such as modeling the behavior of vehicles, pedestrians, cyclists, traffic sign, and/or road conditions. Collision checker 528 receives detections 514 and plan 518 and identifies potential collisions with objects, vehicles, pedestrians, and obstacles. STL module 529 receives detections 514 and plan 518 and verifies temporal properties of AV signals, such as the speed of the vehicle, distance to an obstacle, the state of a traffic light, whether the vehicle appropriately came to a stop before proceeding at a stop sign, etc.

Outputs of auxiliary tools 520 can be provided to re-trained VLM 146, used to augment the input into re-trained VLM 146, and/or used by re-trained VLM 146 to generate program code to compute the risk of a plan 518. As described, re-trained VLM 146 is generated by re-training VLM 118 and can be any type of technically feasible machine learning model that is able to process text and images simultaneously to perform visual-language tasks, such as visual question answering, image captioning, and/or text-to-image search. For example, in various embodiments, re-trained VLM 146 can be a transformer-based VLM, such as LLAMA (Large Language Model Meta AI), with a generative model architecture.

An augmented input into a VLM can include geometry or physics of the surrounding environment and/or objects. For example, the augmented input can indicate that the vehicle approaches “x” meters of a pedestrian. In some embodiments, auxiliary tools 520 can be used to improve prediction output of re-trained VLM 146 for a plan 518. In such cases, auxiliary tools 520 outputs are directly provided to re-trained VLM 146 and used by re-trained VLM 146 to generate a more informed prediction. Auxiliary tools 520 can also be used to identify perception failures, such as not detecting an obstacle or object, not locating the bounding box for an object, etc.

In some embodiments where the input into a VLM is augmented using auxiliary tools 520, and during training or re-training, the VLM can decide whether the VLM output relies on human-annotated labels 132 or relies on surrounding environment information provided by auxiliary tool 520. In addition or alternatively, auxiliary tool 520 can compute generated labels 134 for the VLM output. For example, one or more of auxiliary tools 520 can directly or indirectly determine whether plan 518 is safe, not safe, and/or be used to compute a risk score for plan 518.

Similar to the description of FIG. 1, data store 120 can include training data used for re-training trained VLM 118. The training data can include human-annotated labels 132 and/or generated labels 134 computed using auxiliary tools 520. For example, human annotators could be provided with detections and/or plans in order to label each provided plan as safe, unsafe or assign a risk score for each provided plan. Detections or plans provided to the human annotators can be modified to cover different situations with a range of low to high risks for a balanced training dataset. For example, by adding the location of an obstacle in the vehicle path, the risk of a provided plan can increase. Human-annotated labels 132 and generated labels 134 can indicate whether plans are safe or not (e.g., whether plans results in collisions), which can be used to re-train VLM 118 to assign risk scores to plans, thereby generating re-trained VLM 146. It should be understood that using human-annotated labels 132 can help VLM 118 learn when to trust the outputs of auxiliary tools 520.

In some embodiments, risk assessment can be performed to label each provided plan as safe, unsafe, assign a risk score, or generate a program code that can be evaluated to calculate the risk score. In such cases, the risk assessment can examine whether detections omit critical objects, whether the plan adheres to traffic rules and driving conditions, and/or whether the plan results in any accidents. To do so, re-training application 116 can use a combination of human labels and labels automatically generated by auxiliary tools 122. Auxiliary tools 122 can produce predictions for the future behavior of the objects, and run collision checks against the plan. The risk scores from the risk assessment, or program code to evaluate the risk scores, can serve as the representative output to re-train the trained VLM 118 in some embodiments.

As previously described, auxiliary tools 520 can be used to generate training data for re-training trained VLM 118, such as generated labels 134. In some embodiments, human-annotated labels 132 can be used in lieu of, or in combination with, outputs of auxiliary tool 520 as new training data. For example, one or more of auxiliary tools 520 can used to identify perception failures, such as not detecting an obstacle or object, not locating the bounding box for the object, etc. The identified perception failures can then be labeled as unsafe and used in the training data. In order to add more data with safety critical perception failures, data can be augmented by artificially injecting mistakes at various levels of AV stack 510. For example, detections could be removed from the perception module 512 output, a spurious obstacle could be inserted in the scene, or the plan could be replaced with an alternative, unsafe behavior, such as crossing lane boundaries or colliding with other vehicles. Other than plans that are labeled as unsafe, training data can also include plans that are labeled safe, and there is no need to engage any risk-mitigating maneuvers in such cases. In some embodiments, the output of auxiliary tools 520 can be translated into natural language or code. In such cases, the translated output can be used to train or re-train a VLM.

In some embodiments, re-training application 116 can perform data curation, for example, with random subsampling, in order to expose trained VLM 118 with training data that covers a broad range of inputs (e.g., detections, plans) and outputs (e.g., risk scores). In such cases, a random subsampling of driving data with targeted subsampling informed by analysis of the out of distribution data can be collected. The data curation is informed by safety information which evaluates the performance of a reference perception system on driving data, with the intuition that failure modes of a reference system will be predictive of “hard” situations. Examples of hard situations can be the false positive events of an automatic emergency braking system. Then, for all collected hard situations, re-training application 116 can run a reference perception, prediction, and planning stack to build the full set of inputs that can monitor trained VLM 118. The predictions of hard situations can then be compared against human-annotated labels 132 or generated labels 134 to determine false positives and negatives.

Re-training module 540 is configured to improve trained VLM 118 through continual learning, thereby adapting trained VLM 118 into re-trained VLM 146 that is able to predict risks associated with plans (e.g., plan 518) that are generated by AV stack 510 or generate program code that can be used to predict such risks. To re-train trained VLM 118, re-training module 540 receives trained VLM 118 and the training data including human-annotated labels 132 and/or generated labels 134. Trained VLM 118 can be a VLM that is pre-trained in any technically feasible manner, such as using a large amount of unlabeled data to train VLM 118 to perform next token prediction. Re-training module 540 performs re-training operations to generate re-trained VLM 146. Re-training module 540 can use any technically feasible re-training techniques, such as transfer learning techniques, to re-train trained VLM 118. For example, when trained VLM 118 is a neural network, re-training module 540 can use a training technique such as backpropagation with a gradient descent optimization algorithm to minimize a loss function. In some embodiments, re-training module 540 can monitor the performance of trained VLM 118 and trigger new re-training cycles based on pre-defined criteria such as data drift, performance degradation, or availability of new labeled data.

After re-training, the VLM risk assessment can be calibrated to avoid false alarms. Specifically, let D_{cal}={x₁, . . . , x_{N}} be a dataset of independent and identically distributed samples drawn from a dataset of nominal driving scenarios. Let s (xᵢ) be the risk score given by trained VLM 118 on each of the driving scenarios. A conformal anomaly detection can transform the raw risk scores into p values which can be used to guarantee a false positive rate, that controls the rate of flagging another scenario that is drawn from the same distribution as an anomaly. In practice, a threshold λ is computed as the appropriate empirical quantile of the VLM risk scores evaluated on a calibration dataset {s (x₁), . . . , s (x_{N})}, and classifying all scenarios where s (xᵢ)<λ as nominal. The conformal anomaly detection allows choosing λ to achieve probably approximately correct (PAC) style guarantees on the false positive rate, for example, guaranteeing with probability greater than 1-δ, that for a new scene that is exchangeable with the calibration dataset (e.g., non-anomalous), the chance of incorrectly classifying the scene as anomalous is less than α. The conformal anomaly detection does not directly control the false negative rate (e.g., failing to detect a truly safety critical anomaly as being critical). Doing so with guaranty is extremely difficult, because it is impossible to craft a fully representative dataset of “true anomalies”. The focus is on choosing a threshold so that at least the false positive rate can be controlled with guarantees. The false positive triggers of a risk minimizing maneuver can degrade the quality of driving behavior, and introduce additional safety risks, so such calibration phase is critical to bound any excess risk that the VLM monitor adds to the AV stack.

FIG. 6 is a more detailed illustration of AV application 145 of FIG. 1 according to various embodiments. As shown AV application 145 includes, without limitation, an AV stack 610, auxiliary tools 620, a prompt generator 630, a re-trained VLM 146, an alternative plan generator 634, and a decision module 638. AV stack 610 includes, without limitation, a perception module 612 and a planner 616. Auxiliary tools 620 include, without limitation, a trajectory predictor 622, a traffic simulator 624, a collision checker 626, and a signal temporal logic (STL) module 628. In some embodiments, AV stack 610 and auxiliary tools 620 can be similar to AV stack 510 and auxiliary tools 520, respectively, described above in conjunction with FIG. 5.

In operation, AV application 145 receives sensor data 602. Similar to sensor data 502, sensor data 602 can include image data, LiDAR data, radar data, ultrasound data, CAN bus data, and/or the like acquired by one or more sensors mounted on and/or within a vehicle. AV application 145 processes sensor data 602 using AV stack 610 and utilizes re-trained VLM 146 to generate a safe plan 640. As discussed in greater detail below, safe plan 640 can be selected from (1) a plan generated by AV stack 610 and (2) an alternative safe plan generated by alternative plan generator 634. An example of an alternative safe plan can be to slow down to a stop or perform other risk mitigating maneuvers when an incoming risk is detected. Safe plan 640 is then used to control a vehicle, such as vehicle 400. For example, a controller could receive safe plan 640 and control the vehicle by steering, accelerating, etc. the car according to safe plan 640.

Prompt generator 634 receives detections 614 and plan 618, and prompt generator 634 generates one or more VLM prompts to be executed by re-trained VLM 146. In some embodiments executing a prompt with re-trained VLM 146 generates an output 632 that indicates the risk of implementing plan 618. In the context of VLMs, a prompt refers to an input or instruction provided to the model to generate a response. A prompt can be a question, statement or any kind of natural language text. An example of the prompt provided to re-trained VLM 146 can be “Given the provided detections and plan, what are the potential issues in detections? What is the overall risk of the plan?”. In some other embodiments executing a prompt with re-trained VLM 146 generates an output 632 that includes program code that can be executed to predict the risk of implementing plan 618. In such cases, an example of the prompt provided to re-trained VLM 146 can be to “Identify critical elements in the scene, reason about the behavior, and craft a cost function which evaluates risk score of the given plan”.

In some embodiments, prompt generator 634 generates VLM prompts by adding sensor data 602, detections 614 and plan 616 to the natural language prompt. In some embodiments, prompt generator 634 can tokenize non-textual data, such as an image and add the tokens as a list to the prompt. For example, in some embodiments, the tokens can be in a foreign language that is reserved for the non-textual data. In some other embodiments, prompt generator 634 can add non-textual data in any other technically feasible manner to the prompt. For example, in some embodiments, the non-textual data can be converted to one or more embeddings that are added to the prompt. In addition to sensor data 602, detection 614, and plan 618, in some embodiments, prompt generator 634 can also add outputs of auxiliary tools 620 to the prompt. For example, because VLMs are sometimes less capable of understanding geometry and physics, prompt generator 634 can use auxiliary tools 620 to compute object trajectories, predicted collisions, etc., which prompt generator 634 can then add to the prompt. Given outputs of auxiliary tools 620, the VLM can provide human-like intuition that considers the context of the scene and the plan to predict, for example, whether a collision with another vehicle that is predicted by auxiliary tools 620 will actually occur or if the other vehicle is likely to slow down to avoid the collision. Although described herein primarily with respect to adding the outputs of auxiliary tools 620 to a prompt that is input into re-trained VLM 146, in some embodiments, re-trained VLM 146 can be given access to auxiliary tools and call those auxiliary tools 620, as appropriate, during execution of a prompt. For example, in some embodiments, re-trained VLM 146 can determine which other vehicles are most critical, and only queries auxiliary tools 620 to check for collisions, etc. with those other vehicles.

Re-trained VLM 146 receives the prompt generated by prompt generator 634 and processes the prompt to generate output 632. Re-trained VLM 146 is trained by re-training application 116, as described above in conjunction with FIG. 5, and re-trained VLM 146 can be any type of technically feasible machine learning model. For example, in various embodiments, re-trained VLM 146 can be a transformer-based VLM with a generative model architecture. In some embodiments in which re-training application 116 trains a VLM from scratch, the trained VLM can be used in place of re-trained VLM 146.

Given the prompt, re-trained VLM 146 generates an output 632 that quantifies the risk of plan 618. In some embodiments, output 632 can be a risk score indicating whether plan 618 is a desirable plan or not. In some embodiments, re-trained VLM 146 can generate a structured output, such as output that includes chain-of-thought reasoning explaining the reasoning that VLM 146 used to arrive at a risk score. In some embodiments, re-trained VLM 146 can generate program code, such as a function that can be evaluated, including using auxiliary tools 620. In such cases, the output of the function can be a risk score for plan 618. For example, the function can use collision checker 626 to check a potential collision in the path of the vehicle provided by plan 618, perform various simulations using other auxiliary tools 620, etc. to arrive at the risk score for plan 618. In some other embodiments, the function can be a conditional function that depends on plan 618 or is based on all inputs to the prompt generator 634.

Alternative plan generator 634 can receive as input, detections 614 and plan 618. Given such inputs, alternative plan generator 634 can generate an alternative plan 608 using the inputs. Alternatively, in some embodiments, alternative plan generator 634 can output a pre-defined alternative plan 608. In such cases, detections 614 and 618 may not need to be received by alternative plan generator 634. An example of a pre-defined alternative plan 608 can be to slow the vehicle down to a stop or other risk mitigating maneuver.

Decision module 638 receives plan 618, alternative plan 608, and output 632 from re-trained VLM 146. Given such inputs, decision module 638 selects safe plan 640. Decision module 638 selects safe plan 640 from plan 618 and alternative plan 608 by applying one or more criteria on output 632. In some embodiments, decision module 638 can use a pre-defined threshold as the criterion. For example, when output 632 is risk score that is below the pre-defined threshold, decision module 638 could select plan 618, and when output 632 is a risk score that is above the pre-defined threshold, decision module 638 could select alternative plan 618. In some embodiments, decision module 638 can be a binary classifier which selects plan 618 or alternative plan 636. In some other embodiments, decision module 638 can use any technically feasible technique to select between plan 618 and alternative plan 636. Although described herein primarily with respect to selecting between plan 618 and alternative plan 636 as a reference example, in some embodiments, decision module 638 can generate safe plan 640 based on output 632 from re-trained VLM 146 in any technically feasible manner, such as by modifying plan 618 (e.g., based on alternative plan 610 that mitigates risk).

FIG. 7 is a flow diagram of method steps for re-training VLM 146, according to various embodiments. Although the method steps are described in conjunction with the systems of FIGS. 1-6, persons skilled in the art will understand that any system configured to perform the method steps in any order falls within the scope of the present embodiments.

As shown, a method 700 begins at step 702, where re-training application 116 receives sensor data 502, trained VLM 118, and optionally human-annotated labels 132. In some embodiments, re-training application 116 receives sensor data 502 and human-annotated labels 132 from data store 120. Sensor data 502 can include any technically feasible data collected from various sensors mounted on and/or within one or more vehicle, such as image data, LiDAR data, radar data, ultrasound sensors data, CAN bus data, and/or the like.

At step 704, re-training application 116 generates detections 514 and plan 518 using AV stack 510. AV stack 510 is a combination of machine learning models and hand-crafted rules that enable a vehicle (e.g., vehicle 400) to drive autonomously. For example, AV stack 510 could include components to perceive the environment, make decisions, and control the vehicle. As described above in conjunction with FIG. 5, in some embodiments, AV stack 510 includes perception module 512 that generates detections 514 and planner 516 that generates a plan for controlling the vehicle. In some other embodiments, AV stack 510 can include a unified machine learning model that receives sensor data 502 and generates plan 518 and detections 514, without requiring separate perception and planner modules.

At step 706, re-training application 116 runs auxiliary tools 520 with the detections 514 and plan 518 to generate auxiliary tool outputs. In some embodiments, re-training application 116 can process detections 514 and/or plan 518 using one or more of auxiliary tools 520 to understand the geometry of objects and/or physics. Examples of auxiliary tools 520 include trajectory predictor 524, traffic simulator 526, collision checker 528, and STL module 529, described above in conjunction with FIG. 5. As described, trajectory predictor 524 receives detections 514 and generates future positions of surrounding objects, such as other vehicles, pedestrians, or cyclists. Traffic simulator 526 can simulate real-world simulations of traffic scenarios, such as modeling the behavior of vehicles, pedestrians, cyclists, traffic sign, and/or road conditions. Collision checker 528 receives detections 514 and plan 518 and identifies potential collisions of the vehicle with objects, other vehicles, pedestrians, and obstacles. STL module 529 receives detections 514 and plan 518 and verifies temporal properties of AV signals, such as a speed of the vehicle, distance to an obstacle, the state of a traffic light, whether the vehicle appropriately came to a stop before proceeding at a stop sign, etc.

During re-training of trained VLM 118, outputs of auxiliary tools 520 can be provided to trained VLM 118, used to augment the input into trained VLM 118, and/or used by code produced by trained VLM 118 to compute the risk of a plan 518 generated by planner 516.

At step 708, re-training application 116 generates generated labels 134 using the auxiliary tool outputs. For example, in some embodiments, auxiliary tools 520 can directly or indirectly determine whether plans are safe, not safe, and/or be used to compute a risk score for plans. Auxiliary tools 520 can also augment inputs to the VLM. As a specific example, when collision checker 528 computes that a collision is likely, re-training application 116 could generate a relatively high risk score, and vice versa. An augmented input into a VLM can include geometry or physics of the surrounding environment and/or objects.

In some embodiments, human-annotated labels 132 can be used in lieu of or in combination with the outputs of auxiliary tool 520 as new training data. In some embodiments, one or more of auxiliary tools 520 can be used to identify perception failures, such as not detecting an obstacle or object, not locating the bounding box for the object, etc. The identified perception failures can then be labeled as unsafe and used in the training data. In order to add more data with safety critical perception failures, data can be augmented by artificially injecting mistakes at various levels of AV stack 510. For example, detections could be removed from the perception module 512 output, a spurious obstacle could be inserted in the scene, or the plan could be replaced with an alternative, unsafe behavior, such as crossing lane boundaries or colliding with other cars. Other than plans that are labeled as unsafe, training data can also include plans that are labeled safe, and there is no need to engage any risk-mitigating maneuvers in such cases. In some embodiments, the output of auxiliary tools 520 can be translated into natural language or code. In such cases, the translated output can be used to train or re-train a VLM.

At step 710, re-training application 116 re-trains a trained VLM using sensor data 502 and generated labels 134 and/or human-annotated labels 132 to generate re-trained VLM 146. Re-trained VLM 146 is trained to output either a risk score or program code that can be used to compute a risk score for a plan generated by AV stack 510 given sensor data, as described above in conjunction with FIG. 6. Re-trained VLM 146 can optionally also take as input the outputs of auxiliary tools. As described, re-training module 540 can use any technically feasible re-training techniques, such as transfer learning techniques, to re-train trained VLM 118. For example, when trained VLM 118 is a neural network, re-training module 540 can use a training technique such as backpropagation with a gradient descent optimization algorithm to minimize a loss function. In some embodiments, re-training module 540 can monitor the performance of trained VLM 118 and trigger new re-training cycles based on pre-defined criteria such as data drift, performance degradation, or availability of new labeled data.

FIG. 8 is a flow diagram of method steps for generating a safe plan to control an autonomous vehicle, according to various embodiments. Although the method steps are described in conjunction with the systems of FIGS. 1-6, persons skilled in the art will understand that any system configured to perform the method steps in any order falls within the scope of the present embodiments.

As shown, a method 800 begins at step 802, where AV application 145 receives sensor data 602. For example, AV application 145 could receive sensor data 602 from one or more sensors mounted on and/or within vehicle 400. Sensor data 602 can include any technically feasible data, such as image data, LiDAR data, radar data, ultrasound sensor data, CAN bus data, and/or the like.

At step 804, AV application 145 generates detections 614 and plan 618 using AV stack 610. AV stack 610 includes machine learning models and/or hand-crafted rules that enable a vehicle (e.g., vehicle 400) to drive autonomously. For example, AV stack 610 could include components to perceive the environment, make decisions, and control the vehicle. In some embodiments, AV stack 610 includes perception module 612 and planner 616, described above in conjunction with FIG. 6. In some other embodiments, AV stack 610 can include a unified machine learning model that receives sensor data 602 and generates plan 618 and detections 614, without requiring separate perception and planner modules. In such embodiments, the unified machine learning model can be any technically feasible machine learning model, such as a Transformer-based neural network.

Detections 614 generated by AV stack 620 can include detected objects, obstacles, or detected traffic signs, or boundaries and/or locations of such objects and traffic signs. Detections 514 can also include map related information such as lane markings, lane curvature, road classification, and road boundaries. Perception module 612 in AV stack 610 receives sensor data 602 and generates detections 614. Perception module 612 can use any suitable technique(s) to generate detections 614, such as object detection, object classification, segmentation, localization and/or tracking to generate detections 614.

Plan 618 generated by the AV stack 610 can include the coordinates defining a path of the vehicle. In some embodiments, given detections 614, planner 616 can include rules that are designed to control the vehicle and selected by a regression model. In some other embodiments, planner 616 can receive detections 614 as input and use one or more machine learning models to generate one or more plans. In some other embodiments, planner 516 can generate a sequence of plans executing one after each other. In some other embodiments, planner 616 can perform an optimization process that minimizes one or more hand-crafted cost functions with different criteria.

At step 806, AV application 145 optionally runs auxiliary tools 620 with detections 614 and plan 618 to generate auxiliary tool outputs. Given as inputs detections 614 and/or plan 618, auxiliary tools 520 can process such inputs to understand the geometry of objects and/or physics. For example, auxiliary tools 520 could compute the collision of the vehicle with obstacles or compute a safe plan for navigating the vehicle. Examples of auxiliary tool 620 include trajectory predictor 622, traffic simulator 624, collision checker 626 and STL module 628, described above in conjunction with FIG. 6. Trajectory predictor 622 receives detections 614 and generates future positions of surrounding objects, such as other vehicles, pedestrians, and/or cyclists. Traffic simulator 624 can simulate real-world simulations by modeling the behavior of vehicles, pedestrians, cyclists, traffic sign, and/or road conditions. Collision checker 626 receives detections 614 and plan 618 and identifies potential collisions with objects, vehicles, pedestrians, and obstacles. STL module 628 receives detections 614 and plan 618 and verifies temporal properties of AV signals, such as a speed of the vehicle, distance to an obstacle, the state of a traffic light, whether the vehicle appropriately came to a stop before proceeding at a stop sign, etc.

Outputs of auxiliary tools 620 can be provided to re-trained VLM 146, used to augment the input given to re-trained VLM 146, and/or used by code output by re-trained VLM 146 to compute the risk of a plan 618.

At step 808, AV application 145 generates a prompt with detections 614, the generated plan 618, and the (optional) auxiliary outputs. A prompt can be a question, statement, or any kind of natural language text. In some embodiments, prompt generator 634 generates prompts by adding sensor data 602, detections 614, and plan 616 to a natural language prompt. In some embodiments, prompt generator 634 can tokenize non-textual data, such as an image, and add the tokens as a list to the prompt. For example, in some embodiments, the tokens can be in a foreign language that is reserved for the non-textual data. In some other embodiments, prompt generator 634 can add non-textual data in any other technically feasible manner to the prompt. For example, in some embodiments, the non-textual data can be converted to one or more embeddings that are added to the prompt. In addition to sensor data 602, detection 614, and plan 618, in some embodiments, prompt generator 634 can also add outputs of auxiliary tools 520 to the prompt. Although described herein primarily with respect to adding the outputs of auxiliary tools to a prompt that is input into re-trained VLM 146, in some embodiments, re-trained VLM 146 can be given access to auxiliary tools and call those auxiliary tools, as appropriate, during execution of a prompt. For example, in some embodiments, re-trained VLM 146 can determine which other vehicles are most critical, and only queries auxiliary tools to check for collisions, etc. with those other vehicles.

At step 810, AV application 145 generates an output 632 by executing re-trained VLM 146 with the generated prompt. In some embodiments, AV application 145 inputs the generated prompt into re-trained VLM 146, which processes the prompt to generate output 632. In some embodiments, re-trained VLM 146 can be generated by re-training application 116 according to the method 700, described above in conjunction with FIG. 7.

In some embodiments, given the prompt, re-trained VLM 146 generates an output 632 that quantifies the risk of plan 618. In such cases, output 632 can be a risk score for plan 618 indicating whether plan 618 is a desirable plan or not. In some embodiments, re-trained VLM 146 can generate a structured output, such as chain-of-thought reasoning explaining the reasoning that VLM 146 used to arrive at the risk score. In some other embodiments, re-trained VLM 146 can generate program code, such as a function that can be evaluated using auxiliary tools 620 to compute a risk score for plan 618. For example, the function could use collision checker 626 to check a potential collision in the path of the vehicle provided by plan 618, call other auxiliary tools 620 to perform various simulations, etc. to determine a risk score. In some other embodiments, the function can be a conditional function that depends on plan 618 or based on all inputs to the prompt generator 634.

At step 812, AV application 145 selects between the generated plan 618 and an alternative plan 636 using the generated output 632. In some embodiments, alternative plan 636 can be generated by alternative plan generator 634 using detections 614 and plan 618, as described above in conjunction with FIG. 6. Alternatively, in some embodiments, alternative plan generator 634 can output a pre-defined alternative plan 636. Decision module 638 of AV application 145 receives plan 618, alternative plan 636, and output 632 from re-trained VLM 146, and selects safe plan 640 from plan 618 and alternative plan 608 by applying a criterion on output 632. In some embodiments, decision module 638 can use a pre-defined threshold as the criterion, as described above in conjunction with FIG. 6. For example, when the risk score of output 632 is below the pre-defined threshold, decision module 638 could select plan 618, and when the risk score of output 632 is above the pre-defined threshold, decision module 638 could select alternative plan 608. In some embodiments, decision module 638 can be a binary classifier that selects plan 618 or alternative plan 636. In some other embodiments, decision module 638 can use any feasible technique to select between plan 618 and alternative plan 636. Although described herein primarily with respect to selecting between plan 618 and alternative plan 636 as a reference example, in some embodiments, decision module 638 can generate safe plan 640 based on output 632 from re-trained VLM 146 in any technically feasible manner, such as by modifying plan 618.

At step 814, AV application 145 controls an AV with the selected plan. For example, in some embodiments, AV application 145 can transmit the selected plan to a controller that controls the vehicle by steering, accelerating, and braking according to safe plan 640.

In sum, a VLM powered runtime monitoring system for controlling AVs is described. In some embodiments, the runtime monitoring system inputs, into a VLM, sensor data, detections such as detected obstacles within an environment, and a generated plan of future behavior for a vehicle. In such cases, the runtime monitoring system can generate a prompt for the VLM that includes embeddings or natural language words representing the sensor data, the detections, and the plan. The prompt asks the VLM to evaluate the plan for safety risks. In some embodiments, the prompt can also include outputs of auxiliary tools, such as physics-based or geometry-based models that compute trajectories of objects, check for collisions, perform simulations, and/or the like. Given the prompt, the VLM generates a risk score or program code that can be executed to compute the risk score and that can utilize the auxiliary tools. A fallback decision logic decides to execute the plan or to perform an alternate maneuver, such as a predefined maneuver to minimize risk. In some embodiments, the VLM can be trained be fine-tuning a pre-trained VLM using training data that includes risk scores for sensor data that are automatically generated using the auxiliary tools or annotated manually.

At least one technical advantage of the disclosed techniques relative to the prior art is that, with the disclosed techniques, runtime monitoring of an AV system uses a VLM to understand broader contexts in an environment, such as understanding the likely behaviors of unusual but relevant obstacles or traffic elements. In addition, with the disclosed techniques, an AV can be correctly controlled to adapt to specific environmental conditions, such as slowing down to avoid obstacles or remaining on the road, resulting in the AV being driven in a relatively safe manner. These technical advantages represent one or more technological improvements over prior art approaches.

1. In some embodiments, a computer-implemented method for controlling vehicles comprises generating, based on sensor data, a first plan for controlling a vehicle, generating, using a trained visual language model (VLM), a final plan for controlling the vehicle based on the first plan and a second plan, and controlling the vehicle based on the final plan.

2. The computer-implemented method of clause 1, wherein generating the final plan comprises processing a plurality of embeddings or tokens associated with the sensor data, one or more detections based on the sensor data, and the first plan via the trained VLM to generate a risk score, and selecting the first plan or the second plan as the final plan based on the risk score.

3. The computer-implemented method of clauses 1 or 2, wherein at least one of geometric information or physics information associated with the one or more detections is also processed via the trained VLM to generate the risk score.

4. The computer-implemented method of any of clauses 1-3, further comprising computing at least one collision, trajectory, or simulation based on the one or more detections, wherein the at least one collision, trajectory, or simulation is also processed via the trained VLM to generate the risk score.

5. The computer-implemented method of any of clauses 1-4, wherein the one or more detections include at least one of a detected object, a bounding box, or map information.

6. The computer-implemented method of any of clauses 1-5, wherein generating the final plan comprises processing a plurality of embeddings or tokens associated with the sensor data, one or more detections based on the sensor data, and the first plan via the trained VLM to generate program code, and executing the program code to select the first plan or the second plan as the final plan.

7. The computer-implemented method of any of clauses 1-6, wherein executing the program code comprises invoking one or more functions to compute geometric or physics information associated with the one or more detections.

8. The computer-implemented method of any of clauses 1-7, further comprising performing one or more operations to re-train a pre-trained VLM based on at least one of one or more predefined labels or one or more generated labels that are associated with additional sensor data to generate the trained VLM.

9. The computer-implemented method of any of clauses 1-8, wherein the second plan is a predefined plan.

10. The computer-implemented method of any of clauses 1-9, further comprising generating the second plan based on the sensor data.

11. In some embodiments, one or more non-transitory computer-readable media store instructions that, when executed by one or more processors, cause the one or more processors to perform the steps of generating, based on sensor data, a first plan for controlling a vehicle, generating, using a trained visual language model (VLM), a final plan for controlling the vehicle based on the first plan and a second plan, and controlling the vehicle based on the final plan.

12. The one or more non-transitory computer-readable media of clause 11, wherein generating the final plan comprises processing a plurality of embeddings or tokens associated with the sensor data, one or more detections based on the sensor data, and the first plan via the trained VLM to generate a risk score, and selecting the first plan or the second plan as the final plan based on the risk score.

13. The one or more non-transitory computer-readable media of clauses 11 or 12, wherein at least one of geometric information or physics information associated with the one or more detections is also processed via the trained VLM to generate the risk score.

14. The one or more non-transitory computer-readable media of any of clauses 11-13, wherein the instructions, when executed by the one or more processors, further cause the one or more processors to perform the steps of computing at least one collision, trajectory, or simulation based on the one or more detections, wherein the at least one collision, trajectory, or simulation is also processed via the trained VLM to generate the risk score.

15. The one or more non-transitory computer-readable media of any of clauses 11-14, wherein generating the final plan comprises modifying the first plan.

16. The one or more non-transitory computer-readable media of any of clauses 11-15, wherein generating the final plan comprises processing a plurality of embeddings or tokens associated with the sensor data, one or more detections based on the sensor data, and the first plan via the trained VLM to generate program code, and executing the program code to select the first plan or the second plan as the final plan.

17. The one or more non-transitory computer-readable media of any of clauses 11-16, wherein executing the program code comprises invoking a function to compute geometric or physics information associated with the one or more detections.

18. The one or more non-transitory computer-readable media of any of clauses 11-17, wherein the instructions, when executed by the one or more processors, further cause the one or more processors to perform the step of performing one or more operations to train a VLM based on at least one of one or more predefined labels or one or more generated labels that are associated with additional sensor data to generate the trained VLM.

19. The computer-implemented method of any of clauses 11-18, wherein the second plan is either a predefined plan or a plan generated based on the sensor data.

20. In some embodiments, a system comprises a memory storing one or more software applications, and a processor that, when executing the one or more software applications, is configured to perform the steps of generating, based on sensor data, a first plan for controlling a vehicle, generating, using a trained visual language model (VLM), a final plan for controlling the vehicle based on the first plan and a second plan, and controlling the vehicle based on the final plan.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for controlling vehicles, the method comprising:
generating, based on sensor data, a first plan for controlling a vehicle;
generating, using a trained visual language model (VLM), a final plan for controlling the vehicle based on the first plan and a second plan; and
controlling the vehicle based on the final plan.

2. The computer-implemented method of claim 1, wherein generating the final plan comprises:
processing a plurality of embeddings or tokens associated with the sensor data, one or more detections based on the sensor data, and the first plan via the trained VLM to generate a risk score; and
selecting the first plan or the second plan as the final plan based on the risk score.

3. The computer-implemented method of claim 2, wherein at least one of geometric information or physics information associated with the one or more detections is also processed via the trained VLM to generate the risk score.

4. The computer-implemented method of claim 2, further comprising:
computing at least one collision, trajectory, or simulation based on the one or more detections,
wherein the at least one collision, trajectory, or simulation is also processed via the trained VLM to generate the risk score.

5. The computer-implemented method of claim 2, wherein the one or more detections include at least one of a detected object, a bounding box, or map information.

6. The computer-implemented method of claim 1, wherein generating the final plan comprises:
processing a plurality of embeddings or tokens associated with the sensor data, one or more detections based on the sensor data, and the first plan via the trained VLM to generate program code; and
executing the program code to select the first plan or the second plan as the final plan.

7. The computer-implemented method of claim 6, wherein executing the program code comprises invoking one or more functions to compute geometric or physics information associated with the one or more detections.

8. The computer-implemented method of claim 1, further comprising performing one or more operations to re-train a pre-trained VLM based on at least one of one or more predefined labels or one or more generated labels that are associated with additional sensor data to generate the trained VLM.

9. The computer-implemented method of claim 1, wherein the second plan is a predefined plan.

10. The computer-implemented method of claim 1, further comprising generating the second plan based on the sensor data.

11. One or more non-transitory computer-readable media storing instructions that, when executed by one or more processors, cause the one or more processors to perform the steps of:
generating, based on sensor data, a first plan for controlling a vehicle;
generating, using a trained visual language model (VLM), a final plan for controlling the vehicle based on the first plan and a second plan; and
controlling the vehicle based on the final plan.

12. The one or more non-transitory computer-readable media of claim 11, wherein generating the final plan comprises:
processing a plurality of embeddings or tokens associated with the sensor data, one or more detections based on the sensor data, and the first plan via the trained VLM to generate a risk score; and
selecting the first plan or the second plan as the final plan based on the risk score.

13. The one or more non-transitory computer-readable media of claim 12, wherein at least one of geometric information or physics information associated with the one or more detections is also processed via the trained VLM to generate the risk score.

14. The one or more non-transitory computer-readable media of claim 12, wherein the instructions, when executed by the one or more processors, further cause the one or more processors to perform the steps of:
computing at least one collision, trajectory, or simulation based on the one or more detections,
wherein the at least one collision, trajectory, or simulation is also processed via the trained VLM to generate the risk score.

15. The one or more non-transitory computer-readable media of claim 11, wherein generating the final plan comprises modifying the first plan.

16. The one or more non-transitory computer-readable media of claim 11, wherein generating the final plan comprises:
processing a plurality of embeddings or tokens associated with the sensor data, one or more detections based on the sensor data, and the first plan via the trained VLM to generate program code; and
executing the program code to select the first plan or the second plan as the final plan.

17. The one or more non-transitory computer-readable media of claim 16, wherein executing the program code comprises invoking a function to compute geometric or physics information associated with the one or more detections.

18. The one or more non-transitory computer-readable media of claim 11, wherein the instructions, when executed by the one or more processors, further cause the one or more processors to perform the step of performing one or more operations to train a VLM based on at least one of one or more predefined labels or one or more generated labels that are associated with additional sensor data to generate the trained VLM.

19. The computer-implemented method of claim 1, wherein the second plan is either a predefined plan or a plan generated based on the sensor data.

20. A system, comprising:
a memory storing one or more software applications; and
a processor that, when executing the one or more software applications, is configured to perform the steps of:
generating, based on sensor data, a first plan for controlling a vehicle,
generating, using a trained visual language model (VLM), a final plan for controlling the vehicle based on the first plan and a second plan, and
controlling the vehicle based on the final plan.
